(19) United States
(12) Patent Application Publication
(10) Pub. No.: US 2014/0016461 A1
(43) Pub. Date: Jan. 16, 2014

(54) PACKET RELAY DEVICE AND METHOD

(71) Applicants: Yuichi Ishikawa, Tokyo (JP); Takeki Yazaki, Tokyo (JP)

(72) Inventors: Yuichi Ishikawa, Tokyo (JP); Takeki Yazaki, Tokyo (JP)

(73) Assignee: ALAXALA NETWORKS CORPORATION, Kanagawa (JP)

(21) Appl. No.: 14/006,107

(22) PCT Filed: Feb. 8, 2012
(86) PCT No.: PCT/JP2012/052828

§ 371 Date: Sep. 19, 2013

(30) Foreign Application Priority Data
Aug. 8, 2011 (JP) 2011-172611

(51) Int. Cl. H04L 12/801

(52) U.S. Cl. CPC H04L 47/35
USPC 370/230

(57) ABSTRACT

When a delay between a packet relay device and a receiving terminal increases, congestion notifications are delayed, and communication quality declines. When a flow is assessed to be in a congestion state, a packet delay device overwrites, within a packet header of an acknowledgement packet for the flow which is received thereafter from a receiving terminal, a field which denotes a network congestion state with a value which denotes that a congestion state is in effect, and transmits same as an acknowledgement packet. It is thus possible to issue a congestion notification over a path from the packet relay device to the receiving terminal, eliminating a congestion notification path from the packet relay device to the receiving terminal and from the receiving terminal to the packet relay device, facilitating avoiding a decline in communication quality even if the delay between the packet relay device and the receiving terminal increases.

### TECHNICAL FIELD

The present invention relates to a bandwidth monitoring technique for a packet relay device in a network, particularly, a device including a congestion notification function.

### BACKGROUND ART

ECN (Explicit Congestion Notification) as one congestion notification technique has drawn much attention. Specifically, the ECN has been implemented in the OS (Operation System), such as LINUX (registered trademark), WINDOWS (registered trademark), as an option function, and has also been discussed in IETF (Internet Engineering Task Force).

The ECN is a congestion notification technique for informing a receiving terminal of congestion information (see Patent document 1). For the congestion notification, when a congestion occurs in a packet relay device (router/switch) included in a network, the router/switch itself explicitly marks congestion information for a data packet transmitted from a transmitting terminal, and transmits it to the receiving terminal.

### CITATION LIST

### Patent Literature

Patent document 1: Japanese Unexamined Patent Application Publication No. 2010-232876
Patent document 2: Japanese Unexamined Patent Application Publication No. 2009-239401
Patent document 3: Japanese Unexamined Patent Application Publication No. Hei 11-341076

### Non-Patent Literature

Non-patent document 1: RFC2474, “Definition of the Differentiated Services Field (DS Field) in the IPv4 and IPv6 Headers”, (ttp://www.ietf.org/rfc/rfc2474.txt)
Non-patent document 2: RFC2475, “An Architecture for Differentiated Services” (ttp://www.ietf.org/rfc/rfc2475.txt)
Non-patent document 3: NII Journal No. 3 (2001, 11): Special feature: Information Platform Tutorial Paper “Traffic Control for QoS Guarantee in Communication Networks”, Yusheng J I, National Institute of Informatics (ttp://www.nii.jp/journal/pdf/03/03-03.pdf)

### SUMMARY OF THE INVENTION

### Problems to be Solved by the Invention

In a congestion avoidance function of the conventional TCP (Transmission Control Protocol), there has been no means for explicitly informing a transmitting and receiving terminals about congestion occurrence. Thus, it has been a mechanism in which the transmitting terminal autonomously determines congestion occurrence, upon detection of occurrence of packet discard in the network by a time-out or duplicate ACK reception. When it is determined that a congestion has occurred, congestion avoidance is realized by suppression of a transmission bandwidth by the transmitting terminal.

If the packet is discarded, application processing cannot normally be executed at the receiving terminal until discarded packet data is compensated. Therefore, the TCP of the transmitting terminal has a function for retransmitting the discarded packet. Though the discarded packet is retransmitted, arrival of the retransmitted packet to the receiving terminal is delayed from its originally scheduled arrival time of the packet if the packet had not been discarded. Because the retransmission packet is received and the divided data in the form of packets is reconfigured for performing the application processing, the processing timing is delayed, thus causing degradation in communication quality.

In the ECN, congestion is detected in the packet relay device such as a router/switch. In this case, the router/switch performs ECN marking for rewriting an ECN field into a CE (Congestion Experienced) value which implies congestion detection, for performing the relaying without discarding the packet as much as possible. This ECN field is defined in the low two bits of a TOS field of an IP header of a data packet.

The receiving terminal which has received the CE packet sets an ECE (ECN Echo) flag of a TCP control flag into “1”. This flag has been extended for the ECN for informing the transmitting terminal of the congestion detection, in an ACK (Acknowledge) packet to be returned to the transmitting terminal thereafter. Upon detection of the ACK packet with the set ECE flag, the transmitting terminal determines that the network is in a congestion state, and suppresses the transmission bandwidth based on the congestion avoidance function of the TCP without the conventional ECT, thereby performing congestion avoidance. If a process for the congestion avoidance is executed, the transmitting terminal sets a CWR (Congestion Window Reduced) flag (TCP control flag) to a transmission packet. The CWR flag is a TCP control flag which has been extended for the ECN in order to stop setting the ECE flag of the ACK packet returned by the receiving terminal, after the transmitting terminal executes the congestion avoidance process. Upon reception of the packet with the set CWR flag, the receiving terminal stops setting the ECE flag to the ACK packet.

With the ECN, it is possible to suppress discarding the packet when the router/switch detects the congestion, and to suggest suppressing the transmission bandwidth by explicitly informing the transmitting/receiving terminals of the congestion occurrence while relaying the packet. This can suppress degradation in communication quality, due to packet discard and packet retransmission as a result of the discard.

In the conventional congestion avoidance technique for determining occurrence of congestion based on the packet discard, the packet discard due to a fault (bit error) cannot be distinguished from the packet discard due to the congestion in the network. Thus, the congestion avoidance process is performed for the bit error fault, unrelated to the congestion. This may cause a problem of leading an unnecessary decline in the transmission bandwidth. However, in the ECN, the congestion occurrence is explicitly informed to the transmitting and receiving terminals. Therefore, it is possible to avoid the congestion only in the congestion in the network, in explicit distinction between the bit error fault and the network congestion, thus preventing unnecessary decrease in the transmission bandwidth.

In the TCP, upon reception of a data packet, the receiving terminal transmits an ACK packet for the data packet to the transmitting terminal. Upon reception of the ACK packet, the transmitting terminal increases the transmission bandwidth. Upon reception of an ACK packet for congestion notification with an ECE flag based on the ECN, it performs the bandwidth control for decreasing the transmission bandwidth to avoid the congestion.

In the conventional ECN, if congestion occurs in the packet relay device (router/switch), congestion information is issued along the route from the packet relay device→the receiving terminal→the packet relay device→transmitting terminal. Thus, if a delay increases between the packet relay device and the receiving terminal, the congestion notification is also delayed. Until the congestion notification is made, the transmitting terminal increases the transmission bandwidth by an amount corresponding to the received ACK packet though the network is in a congestion state, until the congestion notification is successfully made, resulting in worsening of the congestion state. As a result, the discarded packets increase, and the retransmission packets for compensating for the discarded packets increase as well. This causes a decrease in the effective bandwidth and an increase in the effective delay, thus resulting a degrading in the communication quality.

To solve the above problems, an object of the present invention is to provide a packet relay device and method therefor for enabling to prevent a delay in congestion notification, even when a delay increases from the packet relay device and the receiving terminal.

### Means for Solving the Problem

To attain the above object, according to the present invention, there is provided a packet relay device which relays a packet, including a plurality of input lines and output lines, and a packet search unit which searches for a packet received from the input line, wherein the packet search unit detects a flow including a set of packets identified by information of the packet received from the input line, and when determined that the detected flow is in a congestion state, the packet search unit rewrites a field representing a congestion state into a value representing that it is in a congestion state, in a header of a response packet for the flow received thereafter.

To attain the above object, according to the present invention, there is provided a packet relay method for a packet relay device including a plurality of input lines and output lines, the method including: detecting a flow including a set of packets identified by information of a packet received from the input line; and when determined that the detected flow is in a congestion state, rewriting a field representing a congestion state into a value representing that it is in a congestion state, in header information of a response packet for the corresponding flow, the packet being received thereafter.

### Effect of the Invention

According to the present invention, a delay in the congestion notification can be prevented, even when a delay increases from the router/switch to the receiving terminal.

It is possible to prevent a delay in the congestion notification, even for the congestion which has been determined by a packet relay device without the present invention.

Further, a congestion notification system can be realized, even in a case where the receiving terminal does not include a congestion notification function.

### BRIEF DESCRIPTION OF THE DRAWINGS

FIG. 1 is a diagram for explaining the basic configuration in congestion notification by a packet relay device according to various embodiments.

FIG. 2 is a diagram showing one configuration example of a packet relay device according to a first embodiment.

FIG. 3 is a diagram showing one example of a packet receiving circuit of the packet relay device according to the first embodiment.

FIG. 4A is a diagram showing one configuration example of a packet receiving buffer according to the first embodiment.

FIG. 4B is a diagram showing one example of packet header information according to the first embodiment.

FIG. 5 is a diagram showing one example of a TOS field according to the first embodiment.

FIG. 6 is a diagram showing one example of a TCP flag according to the first embodiment.

FIG. 7 is a diagram showing one configuration example of a flow search unit according to the first embodiment.

FIG. 8 is a diagram showing one configuration example of a flow search table according to the first embodiment.

FIG. 9 is a diagram showing one configuration example of a bandwidth monitoring unit according to the first embodiment.

FIG. 10 is a diagram showing one configuration example of a bandwidth monitoring table according to the first embodiment.

FIG. 11 is a diagram showing a flowchart of a leaky bucket algorithm according to the first embodiment.

FIG. 12 is a diagram showing one configuration example of a congestion state management table (for each bandwidth monitoring entry) according to the first embodiment.

FIG. 13 is a diagram for schematically explaining a congestion process according to the first embodiment.

FIG. 14 is a diagram showing another configuration example of a flow search unit according to the first embodiment.

FIG. 15 is a diagram showing one example of a flow action table of a flow search unit according to the first embodiment.

FIG. 16 is a diagram showing another configuration example of a packet receiving circuit according to the first embodiment.

FIG. 17 is a diagram showing another configuration example of a packet receiving buffer according to the first embodiment.

FIG. 18 is a diagram showing one configuration example of an ECN marking threshold table according to the first embodiment.

FIG. 19 is a diagram schematically showing a congestion process in accordance with the magnitude relationship of the number of packets stored in a buffer, the number of buffer planes, and the ECN marking value, according to the first embodiment.

FIG. 20 is a diagram showing one configuration example of a packet transmitting circuit according to the first embodiment.

FIG. 21 is a diagram showing one configuration example of a transmission bandwidth management table (for each line) according to the first embodiment.

FIG. 22 is a diagram showing a flowchart of a process of the packet transmitting circuit according to the first embodiment.

FIG. 23 is a diagram showing a flowchart of communication using the packet relay device according to the first embodiment.

FIG. 24 is a sequence diagram for communication using the packet relay device according to the first embodiment.

FIG. 25 is a diagram showing one configuration example of a transmission bandwidth management table (for each line) according to a second embodiment.

FIG. 26 is a diagram showing one configuration example of a flow search table according to a third embodiment.

FIG. 27 is a diagram showing one configuration example of a flow action table according to the third embodiment.

FIG. 28 is a flowchart of communication using the packet relay device according to the third embodiment.

FIG. 29 is a sequence diagram for communication using the packet relay device according to the third embodiment.

FIG. 30 is a diagram showing one configuration example of a flow search table according to a fourth embodiment.

FIG. 31 is a diagram showing one configuration example of a flow action table according to the fourth embodiment.

FIG. 32 is a diagram showing a flowchart of communication using the packet relay device according to the fourth embodiment.

FIG. 33 is a diagram showing a sequence diagram for communication using the packet relay device according to the fourth embodiment.

### MODE FOR CARRYING OUT THE INVENTION

Descriptions will now be made of modes for carrying out the present invention in accordance with the drawings. Before this, descriptions will be made of the basic configuration of a packet relay device which includes a congestion notification function of the present invention. The basic configuration of the packet relay device of the present invention includes a plurality of input lines and output lines, and detects a flow including a set of packets that are identified by at least one or more items of information of an input physical line number of a packet received from an input line, an input logical line number, or packet header information. When it is determined that the flow is in a congestion state, the field representing the congestion state of the network is rewritten into a value representing that it is in a congestion state, in the packet header of a response packet received subsequently, for the corresponding flow.

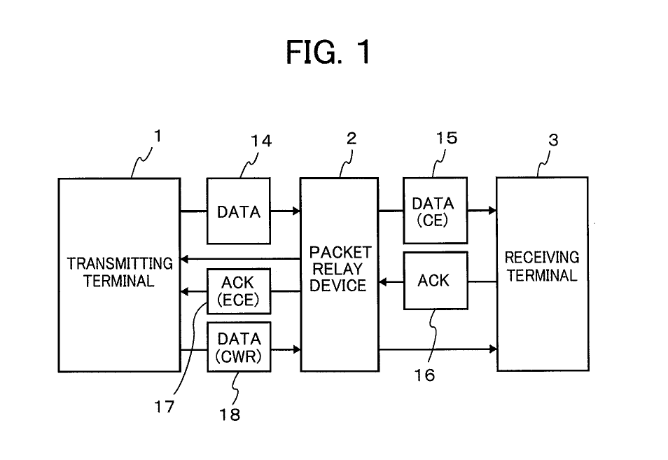

Descriptions will now be made of a process and effect of the basic configuration of the packet relay device of the present invention, using FIG. 1. Let it be assumed that the transmitting terminal 1 and the receiving terminal 3 are in congestion notification using ECN (Explicit Congestion Notification). When a packet relay device 2 receives a data packet 14 transmitted from the transmitting terminal 1, if determined that the flow to which the data packet 14 belongs is in a congestion state, subsequently, the packet relay device 2 receives a response packet (ACK) 16 of a TCP transmitted from the receiving terminal 3. Then, it rewrites an ECE (ECN Echo) flag of this ACK packet 16 from “0” to “1”, and transmits it to the transmitting terminal 1 as an ACK packet (ECE) 17. As a result, the congestion notification can be made along the route from the packet relay device 2 to the transmitting terminal 1. Upon reception of this congestion notification, the transmitting terminal 1 reduces the window size, sets a CWR (Congestion Window Reduce) flag for informing the reduction, and transmits data (CWR) 18.

In the flow of a process of the packet relay device without the above-described basic configuration of the present invention, when the packet relay device 2 receives a data packet 14 transmitted from the transmitting terminal 1, it may be determined that the flow to which the corresponding data packet 14 belongs is in the congestion state. Then, the packet relay device 2 rewrites the ECN field of the data packet 14 into “11” (Congestion Experienced: CE), and transmits it to the receiving terminal 3 as a data packet (CE) 15. Upon reception of the data packet (CE) 15, the receiving terminal 3 sets “1” for the ECE (ECN Echo) flag of an ACK packet to be subsequently transmitted, because the ECN field has a value “11” (CE) representing congestion occurrence, and then transmits the ACK (ECE). Upon reception of the ACK (ECE), the packet relay device 2 transmits it to the transmitting terminal 1 as is as ACK (ECE) 17. Thus, congestion notification is made along the route from the packet relay device 2 to the receiving terminal 3, from the receiving term terminal 3 to the packet relay device 2, and from the packet relay device 2 to the transmitting terminal 1.

As obvious from the above, according to the basic configuration of the packet relay device of the present invention, the route of the congestion notification can be reduced by the omission of the route from the packet relay device 2 to the receiving terminal 3 and from the receiving terminal 3 to the packet relay device 2. As a result, even if a delay increases between the packet relay device 2 and the receiving terminal 3, the congestion notification is not delayed, thus attaining an effect of preventing degradation in communication quality.

### Embodiment 1

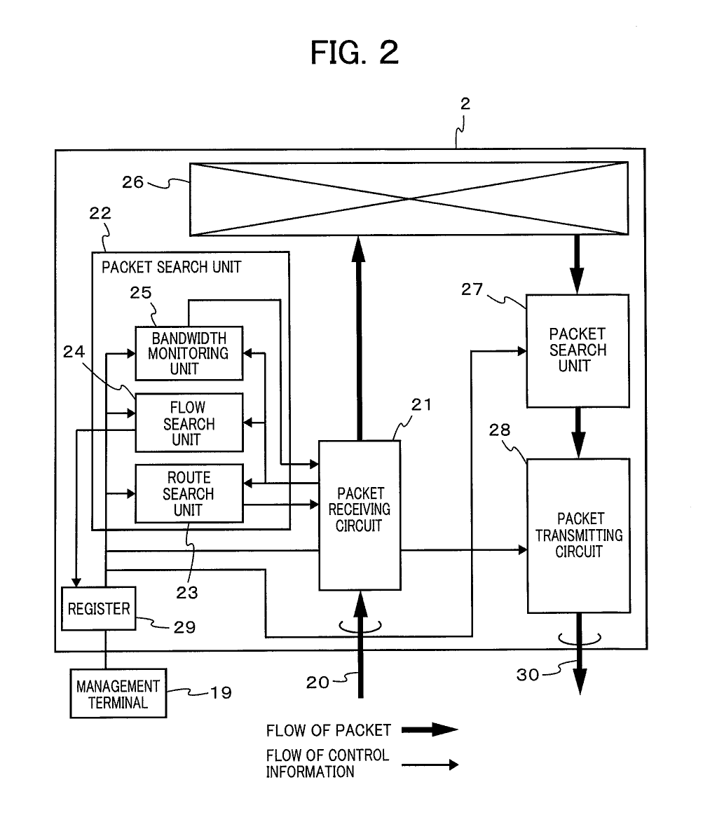

Descriptions will now be made of a packet relay device according to the first embodiment, using FIG. 2 to FIG. 24. In the descriptions below, a TCP/IP packet may be used, and ECN may be used in congestion notification. However, packets of another transport protocol (e.g. DCCP (Data Congestion Control Protocol), SCTP (Stream Control Transmission Protocol)) may be used, and the protocol of another congestion notification may be used.

FIG. 2 shows one configuration example of the packet relay device of this embodiment. The packet relay device 2 is connected to an input line 20 for inputting packets and an output line 30 for outputting packets. The packet relay device 2 includes a packet receiving circuit 21 for performing a process for receiving packets, a packet search unit 22 for input packets, packet relay processing means 26, a packet search unit 27 for input packets, and a packet transmitting circuit 28 for performing a process for reading packets and transmitting the packets. Note that the packet relay processing means 26 performs route search using a route search unit 23 of the packet search unit 22 based on a destination IP address, and performs switching of packets based on a determined output line number. In this embodiment, no specification is made to the search system for determining the output line number based on the route search based on the destination IP address using the route search unit 23 of the packet search unit 22. However, an example of the route search system is disclosed, for example, in Patent document 3.

The packet search unit 22 and the packet search unit 27 are respectively on the receiving side and the transmitting side, and include the same configuration with a flow detecting unit 24 and a bandwidth monitoring unit 25. In this specification, when referred to as the packet search unit, it implies either one or both of the packet search unit 22 and the packet search unit 27. The packet receiving circuit 21 and the packet transmitting circuit 28 include a rewriting function of an ECN field and an ECE field of the packet header.

The configuration of FIG. 2 has one input line 20 and one output line 30, while the packet relay device 2 includes a plurality of input lines 20 and a plurality of output lines 30. The packet receiving circuit 21 and the packet search unit 22 connected thereto can contain the plurality of input lines 20. It may include a plurality of packet receiving circuits 21 and a plurality of packet search units 22 connected thereto, each of which may contain a mutually different plurality of input lines 20. Similarly, the packet transmitting circuit 28 and the packet search unit 27 connected thereto may contain a plurality of input lines. It may include a plurality of packet transmitting circuits 28 and a plurality of packet search units 27 connected thereto, each of which may contain a mutually different plurality of output lines 30. A management terminal 19 may be connected to the packet relay device 2, and manages and performs various settings for the packet relay device 2 through a register.

The packet relay device 2 receives packets from the input line 20 connected to the packet receiving circuit 21. The packets received from the transmitting terminal 1 are input to the packet receiving circuit 21 through the input line 20.

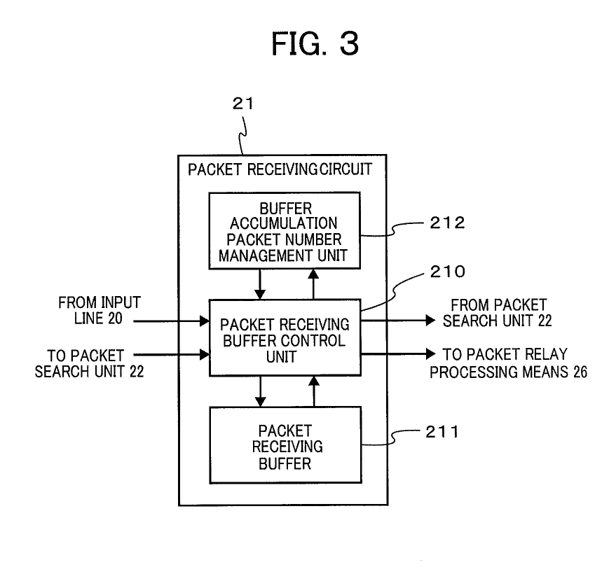

FIG. 3 shows one configuration example of the packet receiving circuit 21 of this embodiment. The packet receiving circuit 21 is composed of a packet receiving buffer control unit 210, a packet receiving buffer 211, and a buffer accumulation packet number management unit 212. The packet receiving buffer control unit 210 controls reading and writing for the packet receiving buffer 211, and performs opening control for permitting overwriting on the buffer plane. The buffer accumulation packet number management unit 212 counts and manages the number of packets accumulated in the packet receiving packet receiving buffer 211.

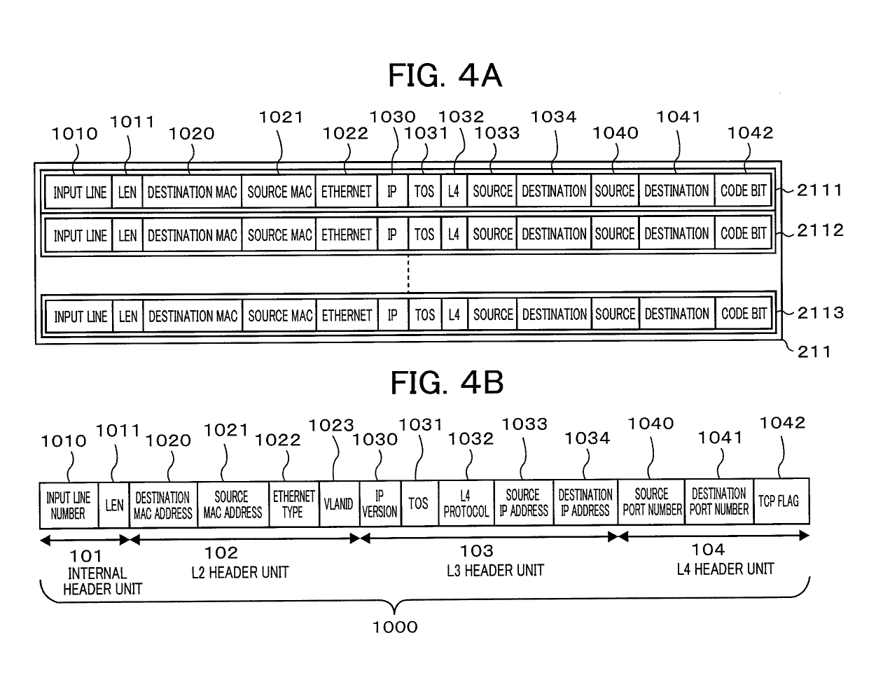

FIG. 4A shows an example of the internal configuration of the packet receiving buffer 211. The packet receiving buffer 211 includes a plurality of buffer planes 2111 to 2113. To each buffer plane, packet header information 1000 for the packet is written, as illustrated in FIG. 4B. The packet header information 1000 includes a destination MAC address 1020 as an L2 header unit 102, a source MAC address 1021, an Ethernet type 1022, a VLAN (Virtual Local Area Network) ID 1023, an IP version 1030 as an L3 header unit 103, a TOS (Type of Service) 1031, an L4 protocol 1032, a source IP address 1033, a destination IP address 1034, a source port number 1040 as an L4 header unit 104, a destination port number 1041, a TCP FLAG 1042, an input line number 1010 as an internal header 101 affixed to the packet receiving circuit 1, and an LEN 1011 representing the byte length of the packet. The configuration of the packet header information 1000 of FIG. 4 is illustrated by way of example, and is not intended to limit the configuration of this embodiment.

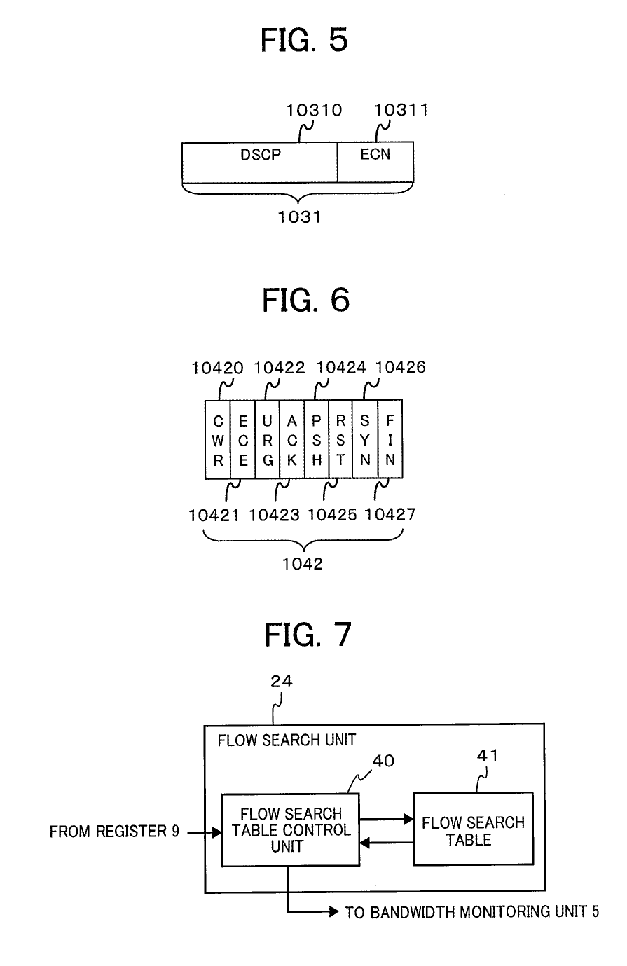

As illustrated in FIG. 5, the TOS 1031 is composed of a DSCP (Differentiated Services Code Point) field 10310 representing the transferring priority in the network and an ECN field 10311 used in the congestion notification using the ECN. The definition of the DSCP is described in the third chapter of Non-patent document 1, while a Diffserv model of the QOS architecture in which the DSCP is applied is described in the second chapter of Non-patent document 2. When the ECN field 10311 has a value of “01” or “10”, it indicates to support ECN (ECN: ECN-Capable-Transport). When it has a value of “11”, it indicates to support that the packets have experienced congestion (CE). The transmitting terminal that supports the ECN transmits packets whose ECN field is set to “01” or “10”. When it is determined that congestion occurs in the packet relay device 2, this field is rewritten into “11” by the packet relay device 2.

As illustrated in FIG. 6, in the TCP flag 1042, in the extension of ECN, CWR 10420 and ECE 10421 are added to existing flags URG 10422, ACK 10423, PSH 10424, RST 10425, SYN 10426, and FIN 10427.

Upon input of packets from the input line 20, the packet receiving circuit 21 of this embodiment illustrated in FIG. 2 and FIG. 3 writes packet header information 1000 of the input packets in the order from the buffer plane 2111 to the buffer plane 2113 of the packet receiving buffer 211 by the packet receiving buffer control unit 210, sequentially in accordance with the order in which the packets are input. When the number of packets accumulated in the buffer managed by the buffer accumulation packet number management unit 212 reaches an “n” number corresponding to the entire number of buffer planes, and when an “n” number of packet header information 1000 is written into the entire buffer planes, the packet receiving circuit 21 stops receiving packets until the firstly-written buffer plane 2111 is open. In addition, when packets are newly input from the input line 20 during the stoppage, they are discarded.

The packets written into the firstly-written buffer 2111 are output to the packet relay processing means 26 upon completion of the process in the packet search unit 22, and their packet header information 1000 may not necessarily be accumulated in the buffer plane 2111. In this case, the packet receiving buffer control unit 210 opens the buffer plane 2111. Subsequently, when packets are newly input from the input line 20, the packet receiving buffer control unit 210 writes packet header information 1000 of the corresponding packets into the open buffer plane 2111.

At a timing at which the packet search unit 22 can receive packets, the packet header information 1000 accumulated in the packet receiving buffer 211 is transmitted. Since completion of the process in the packet search unit 22 until transmission of packets to the packet relay processing means 26, the packet header information 1000 are kept accumulated temporarily in the packet receiving buffer 211. After this, if packets are newly output to the packet relay processing means 26, the buffer planes are open sequentially in the order from the buffer plane 2112 and the buffer plane 2113, and packets newly input from the input line 20 are accumulated in the open buffers sequentially in the open order. The packet search unit 22 includes a route search unit 3 for determining an output line number for identifying the output line 12 and a flow search unit 4 for searching for the flow.

FIG. 7 shows a configuration example of a flow search unit 24 of this embodiment. The flow search unit 24 is composed of a flow search table 41 and a flow search table control unit 40, which performs table-writing and table-reading into and from the flow search table 41 and performs various control, such as table search activation and the like. The flow search table 41 may physically include a CAM (Content Addressable Memory), for example. For an overview of the CAM, see Patent document 2, for example.

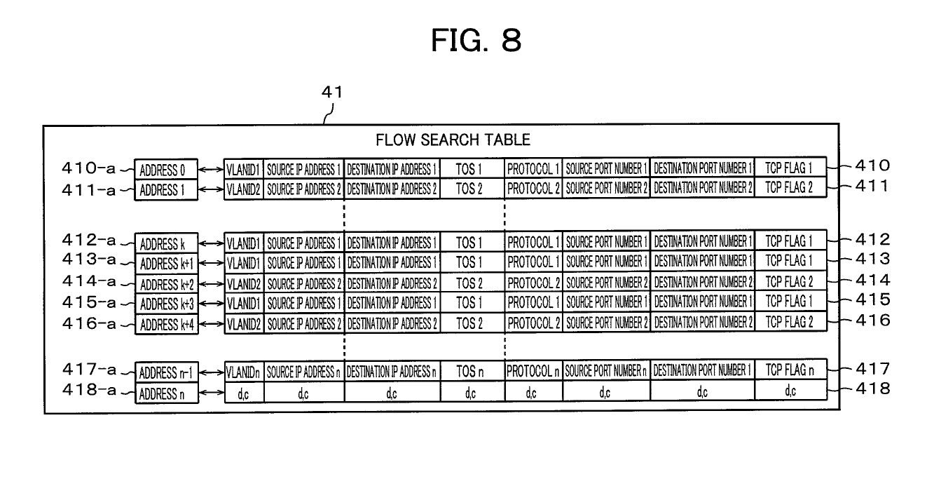

FIG. 8 shows a configuration example of the flow search table 41 of this embodiment. The flow search table 41 includes a plurality of flow search entries 410, 411, . . . 418. As illustrated in FIG. 8, each of the flow search entries 410 to 418 includes various packet header information, such as VLANID, a source IP address, a destination IP address, a TOS, a protocol, a source port number, a destination port number, and a TCP flag. The items of the packet header information included in each flow search entry of FIG. 8 are described herein by way of example, and are not intended to limit the scope of this embodiment.

In FIG. 8, each of the flow search entries 410 to 418 corresponds to a bandwidth monitoring entry, as will be described later. The condition of target flow in bandwidth monitoring in accordance with each bandwidth monitoring entry is set in the flow search entry. The value set in each flow search entry is determined in accordance with the condition of the target packet header in the flow. The condition of the packet header is determined by the operation manager of the packet relay device 2, as a target in the bandwidth monitoring. The operation manager of the packet relay device 2 inputs the condition of the target packet header in the flow, from the management terminal 19. This input value is then input to the flow search table control unit 40 of the flow search unit 24 through the register 9. The flow search table control unit 40 controls writing for the flow search table 41, thereby setting it into the flow search table 41.

Descriptions will hereinafter be made of a process in a case where a corresponding packet is not a response packet of TCP, that is, in a case where “0” is set in ACK 10423 of the TCP flag field 1042 of the packet header information 1000 of the corresponding packet. Descriptions will hereinafter be made of control of the flow search table 41 for the response packet of the TCP.

A search is activated, upon input of packets into the CAM included in the flow search table 41 from the flow search table control unit 40 of the flow search unit 24. Then, the CAM searches for entries sequentially from the flow search entry 410 with an address in the high rank 410-a of the flow search entries toward the flow search entry 418 with an address in the low rank 418-a. Then, it searches for a flow search entry whose information items written in the flow search entry entirely coincide with information items of the packet header. At this time, it is determined that a packet header information item written as “d.c.” coincides with the corresponding packet header information regardless of the value written in the input packet. The address of the first coinciding flow search entry is determined as a hit address, and the hit address is output to the flow search table control unit 40. Based on the hit address, it can be determined with which flow search entry the corresponding packets coincide, and to which bandwidth monitoring entry (described later) the flow corresponds.

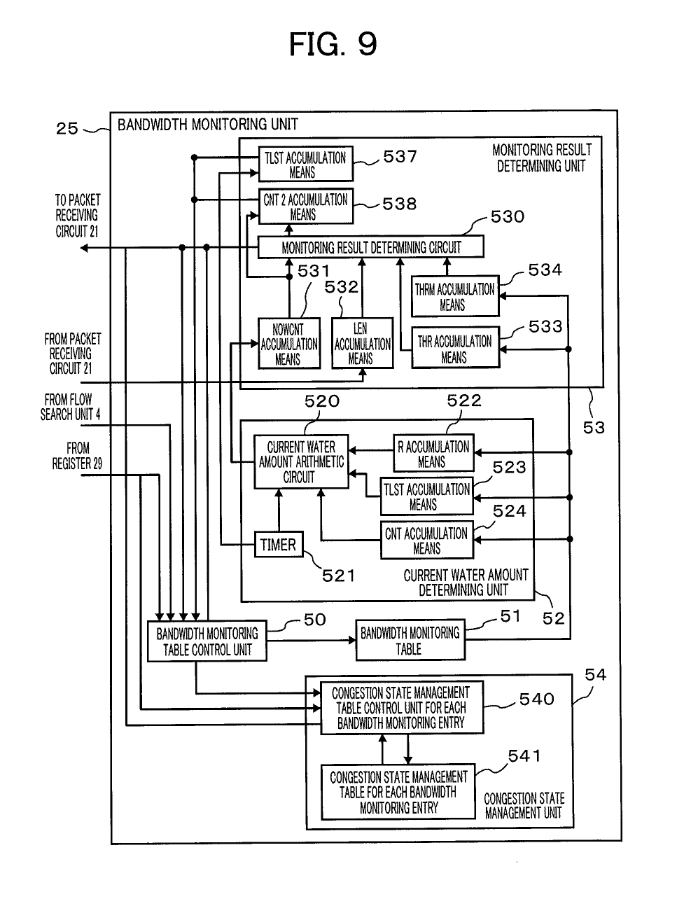

FIG. 9 shows one configuration example of the bandwidth monitoring unit 25 of this embodiment. Hit address information from the flow search unit 24 is output from the flow search table control unit 40 to the bandwidth monitoring unit 25. In FIG. 9, the bandwidth monitoring unit 25 includes a bandwidth monitoring table control unit 50, a bandwidth monitoring table 51, a current water amount determining unit 52, a monitoring to result determining unit 53, and a congestion state management unit (for each bandwidth monitoring entry) 54.

The bandwidth monitoring table control unit 50 controls reading and writing for the bandwidth monitoring table 51. The operation manager of the packet relay device 2 inputs, from the management terminal 9, the condition of a bandwidth in the bandwidth monitoring for each flow determined by the operation manager of the packet relay device 2. As a result, this input value is input to the bandwidth monitoring table control unit 50 of the bandwidth monitoring unit 25 through the register 10, and the bandwidth monitoring table control unit 50 controls writing for the bandwidth monitoring table 51, thereby setting it into the bandwidth monitoring table 51.

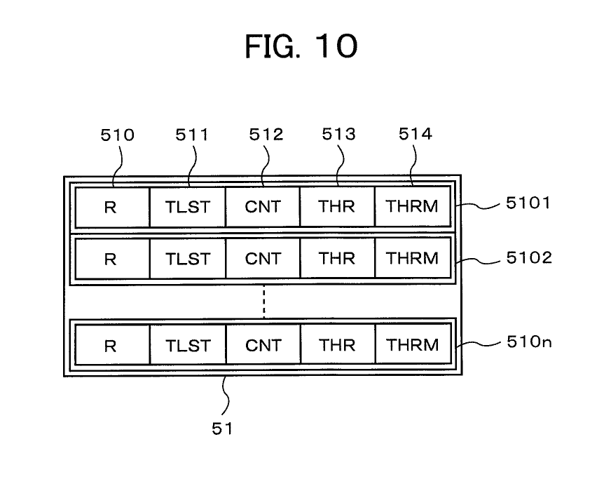

FIG. 10 shows one configuration example of the bandwidth monitoring table 51 of this embodiment. The bandwidth monitoring table 51 is composed of a plurality of bandwidth monitoring entries 5101 to 510n corresponding to the flow search entries of the flow search table 41. Each of the bandwidth monitoring entries is composed of “monitor bandwidth” R 510, “arrival time of previous packet” 511, “bucket water amount” CNT 512, “threshold value” THR 513, and “ECN marking threshold value” THRM 514.

Upon input of packets, the bandwidth monitoring table control unit 50 reads the bandwidth monitoring table 51 using the hit address determined by the flow search unit 24 as a read address for the bandwidth monitoring table 51, and refers to the bandwidth monitoring entry corresponding to the hit address. The R 510, the TLST 511, the CNT 512, the THR 513, and the THRM 514 of the referred bandwidth monitoring entry are accumulated respectively in R accumulation means 522, TLSL accumulation means 523, CNT accumulation means 524, THR accumulation means 533, and THRM accumulation means 534, and are used for determining the bandwidth monitoring. The algorithm in the bandwidth monitoring is, for example, a leaky bucket algorithm.

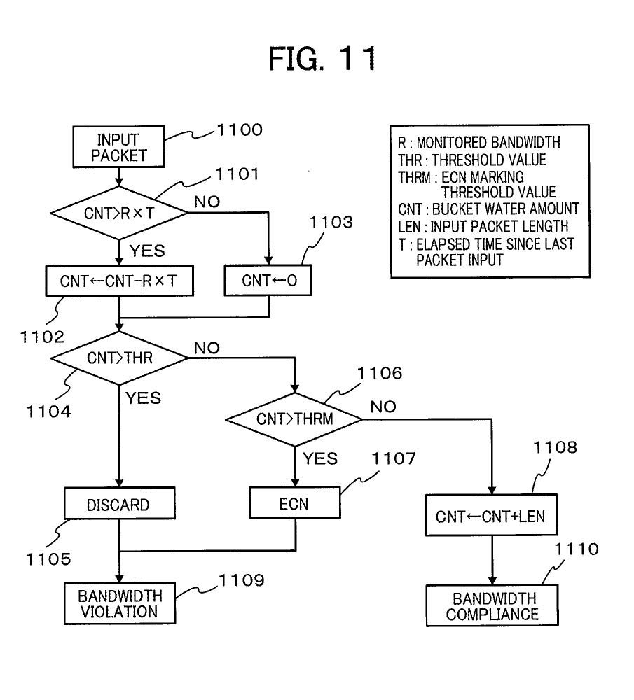

FIG. 11 shows an example of a leaky bucket algorithm. In the illustration, description will now be made along this algorithm, under the assumption that packets are sequentially input (1100). Description will be made of arithmetic in the current water amount determining unit 52. A current water amount determining unit 520 subtracts the TLSL accumulated in the TLSL accumulation means 523 from the current time indicated by the timer 521, thereby obtaining an elapsed time T. Magnitude comparison is made between a product “R×T” of R (accumulated in the R accumulation means 522) and T and the “CNT” accumulated in the CNT accumulation means 524 (1101). As a result, if the “R×T” is larger, the CNT is set to “0” (1103). In the other case, the “R×T” is subtracted from the “CNT” (1102). The CNT determined in the above procedures is accumulated in NOWCNT accumulation means 531.

Descriptions will now be made of the arithmetic by the monitoring result determining unit 53 for determining whether a bandwidth monitoring result indicates a violation or compliance. The LEN accumulation means 532 accumulates the LEN 1011 of the internal header 101 of the packet transmitted from the packet receiving circuit 1. The LEN 1011 is a value representing the byte length of the packet. A monitoring result determining circuit 530 compares the magnitude of the CNT accumulated in the NOWCNT accumulation means 531 with the THR accumulated in the THR accumulation means 533 (1104). When the CNT is larger, it is a bandwidth violation, and the circuit determines that congestion is detected, and discards the packets (1105).

When the CNT is smaller, magnitude comparison is made between the CNT accumulated in the NOWCNT accumulation means 531 and the THRM accumulated in the THRM accumulation means 534 (1106). When the CNT is larger, it is a bandwidth violation (1109), and it is determined as congestion detection, thereby performing ECN marking (1107). The value of the CNT is accumulated in the CNT 2 accumulation means, and the current time indicated by the timer 521 is accumulated in TLST accumulation means 537. In the bandwidth monitoring table 51, the CNT 512 of the bandwidth monitoring entry of a flow with the same packet is rewritten with the CNT accumulated in the CNT 2 accumulation means 538, and the TLST 511 of the bandwidth monitoring entry corresponding to the hit address is rewritten by a timer value accumulated in the TLST accumulation means 537.

As described above, when it is determined as a bandwidth violation (1109) in accordance with the matched condition of CNT>THR or CNT>THRM, and the congestion is detected. Then, information representing the congestion detection from the monitoring result determining circuit 530 and the hit address are output to the congestion state management unit 54. The congestion state management unit 54 is composed of a congestion state management table control unit (for each bandwidth monitoring entry) 540 and a congestion state management table (for each bandwidth monitoring entry) 541. The congestion state management table control unit (for each bandwidth monitoring entry) 540 controls reading and writing for the congestion state management table (for each bandwidth monitoring entry) 541.

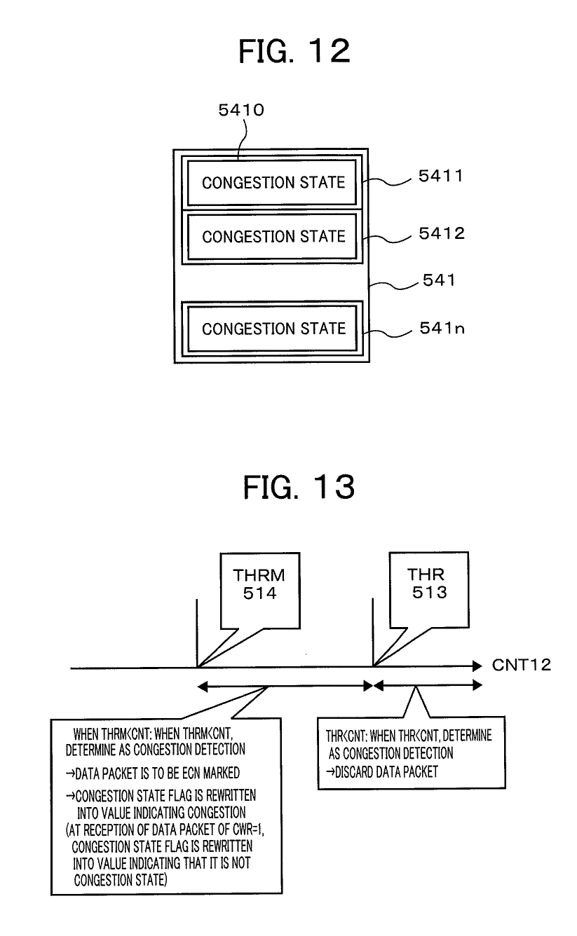

FIG. 12 shows one configuration example of the congestion state management table (for each bandwidth monitoring entry) 541 of this embodiment.

The congestion state management table (for each bandwidth monitoring entry) 541 is composed of a plurality of congestion state management entries (for each bandwidth monitoring entry) 5411 to 541n corresponding to the respective flow search entries of the flow search table 41. Each of the congestion state management entries 5411 to 541n includes a congestion state flag 5410 representing the congestion state of each flow defined by the flow search entry. The congestion state flag 5410 has a value representing that it is not in a congestion state in the initial state. Upon input of the information representing the congestion state from the monitoring result determining circuit 530 and the hit address, the congestion state management unit 54 writes information representing the congestion state into the congestion state flag 5410 of the congestion state management entries (for each bandwidth monitoring entry) 5411 to 541n of the congestion state management table (for each bandwidth monitoring entry) 541, using the hit address as a write address, in accordance with the congestion state management table control unit (for each bandwidth monitoring entry) 540.

In FIG. 11, when there is no matched condition of CNT>THR or CNT>THRM, it is bandwidth compliance (1110). A value obtained by adding LEN to CNT is accumulated in the CNT 2 accumulation means 538 (1108), and the current time indicated by the timer 521 is accumulated in the TLST accumulation means 537. In the bandwidth monitoring table 51, the CNT 512 of the bandwidth monitoring entry corresponding to the hit address is rewritten into the CNT accumulated in the CNT 2 accumulation means 538, and the TLST 511 of the bandwidth monitoring entry of the hit address is rewritten into the value of the timer which is accumulated in the TLST accumulation means 537. When information representing that it is not in a congestion state is output from the monitoring result determining circuit 530, there is not performed a rewriting process of the congestion state flag 5410 of the congestion state management entries 5411 to 541n (for each bandwidth monitoring entry) of the congestion state management table 541 (for each bandwidth monitoring entry).

A known algorithm as an algorithm for bandwidth monitoring is a Jumping Window algorithm using a window system, in addition to a leaky bucket algorithm using a credit system, (see Non-patent document 3). This may be used for bandwidth monitoring. In this case, magnitude comparison is made between an integrated value B of the byte length of a packet transmitted by the packet receiving circuit 21 for each time window W and the number of bytes W×R permitted during the time window W. When B is larger, it is a bandwidth violation. In another case, it is bandwidth compliance, and the same sanction processing is performed as that of the case of the leaky bucket algorithm.

When there is no matched condition of CNT>THR and there is a matched condition of CNT>THRM, information representing that ECN marking is to be performed (1107) is output to the packet receiving circuit 21.

FIG. 13 shows the relationship between bucket water amount CNT 12, threshold THR 513, and ECN marking threshold THRM 514 in the leaky bucket algorithm, as described above.

Upon input of the information representing that the ECN marking is to be performed, the packet receiving circuit 21 reads the value of the ECN field 10311 of the TOS field 1031 of FIG. 5 in the packet header information 1000 of a corresponding packet accumulated in the packet receiving buffer 211 included in the packet receiving circuit 21, in accordance with the packet receiving buffer control unit 210. When the read value of the ECN field 10311 is “10” or “01”, the value is rewritten into “11”. When the read value of the ECN field 10311 is “00” or “11”, the value is not rewritten. The above-described process is a process example in bandwidth monitoring, when the packet input to the packet relay device 2 is data packet.

Descriptions will now be made of a case in which the packet input to the packet relay device 2 of this embodiment is an ACK packet of TCP, that is, a case in which “1” is set in the ACK 10423 of the TCP flag field 1042 of the packet header information 1000 of the corresponding packet, as illustrated in FIG. 6. In the ACK packet of TCP for the data packet transmitted from the transmitting terminal 1 to the receiving terminal 3, the source IP address of the data packet is the destination IP address of the ACK packet, the destination IP address of the data packet is the source IP address of the ACK packets, the source port number of the data packet is the destination port number of the ACK packet, and the destination port number of the data packet is the source port number of the ACK packet.

Thus, when it is determined that ACK=1 (input packet) by the flow search table control unit 40 of the flow search unit 24, search activation for the flow search table 41 is performed by the flow search table control unit 40, under the condition that the source IP address and the destination IP address are exchanged from each other, and the source port number and the destination port number are exchanged. Then, the hit address of the flow search entry with the same data packet corresponding to the ACK packet is output from the flow search table 41. This hit address is output to the congestion state management table control unit (for each bandwidth monitoring entry) 540 of the bandwidth monitoring unit 25 from the flow search table control unit 40, this hit address is used as a read address to control reading of the congestion state management table (for each bandwidth monitoring entry) 541.

Then, a congestion state flag corresponding to the bandwidth monitoring entry for a data packet corresponding to the ACK packet is read by the congestion state management table control unit (for each bandwidth monitoring entry) 540, to determine the congestion state regarding the bandwidth monitoring of the data packet corresponding to the ACK packet. When this congestion state flag has a value indicating that it is in a congestion state, information representing that ECE marking is performed for rewriting the ECE flag of the ACK packet into “1” is output to the packet receiving circuit 21.

Upon input of the information representing that the ECE marking is to be performed, the packet receiving circuit 21 rewrites, into “1”, the value of the ECE field 10421 of the TCP flag field 1042 in the packet header information 1000 of the corresponding packet accumulated in the packet receiving buffer 211 included in the packet receiving circuit 21. It will be possible to perform the ECE marking for the ACK packet with the packet relay device 2 instead of the receiving terminal 3, based on the congestion state of the bandwidth monitoring in the packet relay device 2. That is, the packet relay device 2 uses the ECE flag of the TCP packet as a field representing the congestion state of the network, in the packet header of the ACK packet. As a result, the congestion notification can be made along the route from the packet relay device 2 to the receiving terminal 3, from the receiving terminal 3 to the packet relay device 2, and from the packet relay device 2 to the transmitting terminal 1. When the congestion state flag has a value representing that it is not in a congestion state, this ECE marking is not to be performed.

When the packet input to the packet relay device of this embodiment is a data packet DATA (CWR) (CWR=1), the congestion state management table control unit (for each bandwidth monitoring entry) 540 rewrites the value of the congestion state flag 5410 of the congestion state management entries (for each bandwidth monitoring entry) 5411 to 541n into a value representing that it is not in a congestion state. Note that the entries 5411 to 541n correspond to the flow to which the corresponding packet belongs in the congestion state management table (for each bandwidth monitoring entry) 541. That is, it implies that the packet relay device of this embodiment determines that the congestion state is solved in the flow, when the CWR flag of the received TCP packet has “1”. Therefore, not ECE marking is performed for the ACK packet received thereafter by the packet relay device.

The descriptions have so far been made of the configuration for detecting the congestion state and instructing congestion notification, in the bandwidth monitoring unit 25 included in the packet search unit 22 on the receiving side of this embodiment 1. However, the packet search unit 27 on the transmitting side can also include the bandwidth monitoring unit 25, and the configuration of this embodiment may be applied to the bandwidth monitoring on the transmitting side.

Descriptions will now be made of a modification of a case for detecting the congestion state and instructing congestion notification, in the packet receiving circuit of this embodiment. To disclose an application example regarding an extended buffer configuration in consideration of the packet priority, the packet receiving circuit has a configuration with a plurality of buffers in accordance with the packet priority, for detecting the congestion state for each buffer and instructing congestion notification. In the configuration, the packet priority is determined by the flow search unit.

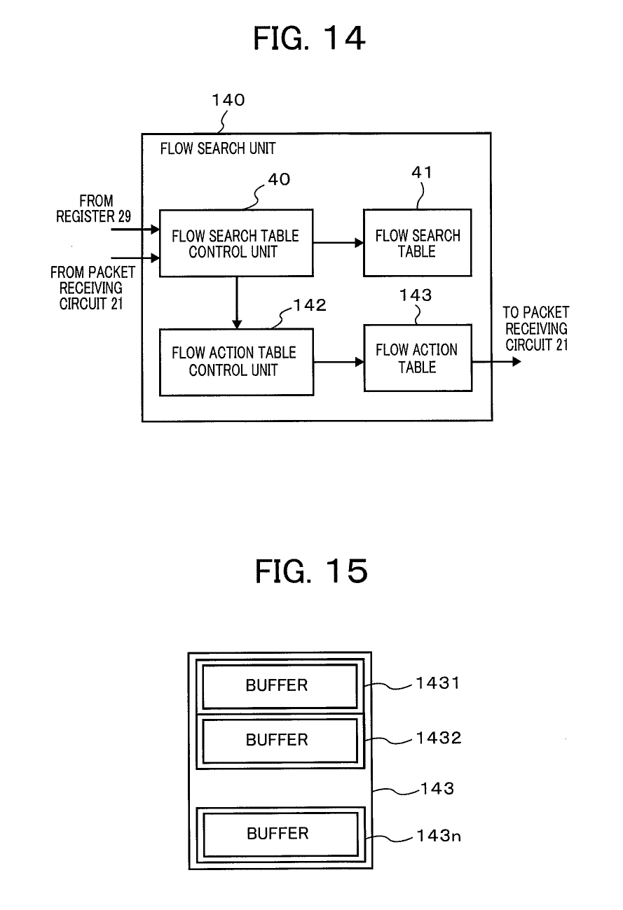

FIG. 14 shows one configuration example of a flow search unit which determines the packet priority, in this modification. A flow search unit 140 includes a flow action table control unit 142 and a flow action table 143, in addition to the configuration of the above-described flow search unit 24 of FIG. 7.

FIG. 15 shows one configuration example of the flow action table 143. The flow action table 143 includes flow action entries 1431 to 143n showing buffer numbers accumulated in the packet receiving buffer 211 of the packet receiving circuit 21 in accordance with the priority of the flow 1 to n. Upon input of packets into the flow search unit 24 packet header information 1000 is input to the flow search table 41 by the flow search table control unit 40, and the hit address of the flow search entry corresponding to this packet header information 1000 is output to the flow search table control unit 40 from the CAM included in the flow search table 41. This hit address is output to the flow action table control unit 142 from the flow search table control unit 40. The flow action table control unit 142 controls reading for the flow action table 143 using this hit address as a read address for the flow action table 143. Then, the flow action entry corresponding to the packet is read, and it is possible to determine the buffer number of the packet receiving buffer 211 of the packet receiving circuit 21, which accumulates the packets.

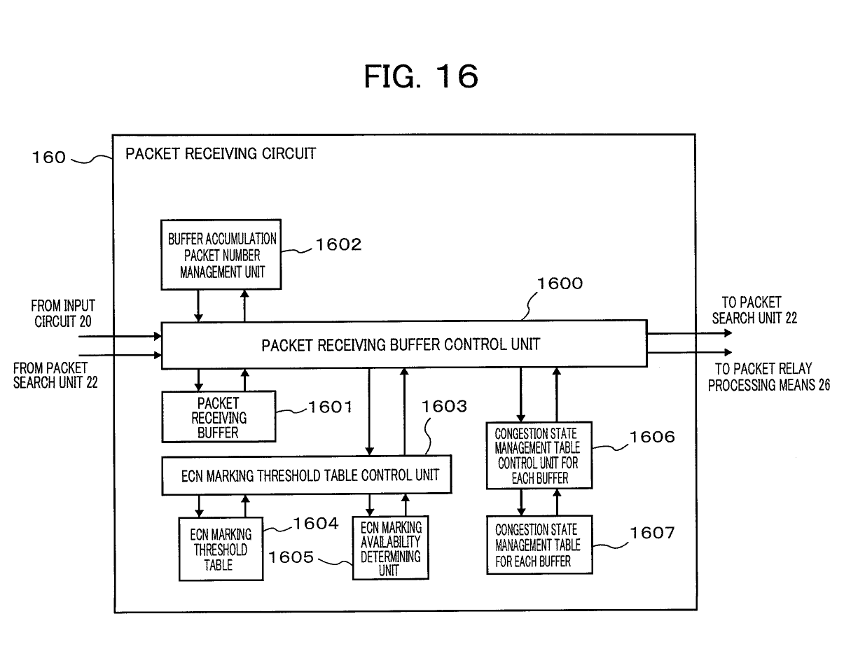

FIG. 16 shows another configuration example of the packet receiving circuit of this embodiment. The packet receiving circuit 160 includes an ECN marking availability determining unit 1603, in addition to the basic configuration of the packet receiving circuit 21 of FIG. 3. The basic configuration includes a packet receiving buffer is control unit 1600, a packet receiving buffer 1601, and a buffer accumulation packet number management unit 1602. The packet receiving buffer 1601 is an extended form of the packet receiving buffer 211, and includes a plurality of buffers in accordance with the priority of the packet.

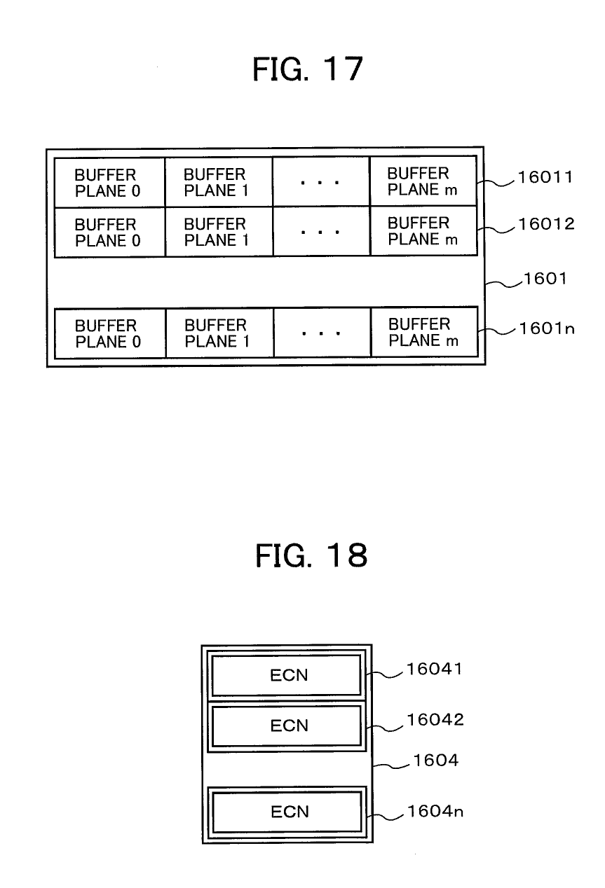

FIG. 17 shows one configuration example of the packet receiving buffer 1601. The packet receiving buffer 1601 includes buffers 16011 to 1601n each of which includes an “m+1” number of planes (buffer plane 0 to buffer plane m). When a packet is input to the packet receiving circuit 21, the packet receiving buffer control unit 210 controls writing of the packet header information 1000 using the hit address of the packet as a write address sequentially from the buffer plane 0, for the buffer 1601i (i: 1 to n) indicated by the buffer number of the packet. The number of packets accumulated in each packet receiving buffer is counted by the buffer accumulation packet number management unit 1602. The number of accumulated packets for each buffer which is counted by the buffer accumulation packet number management unit 1602 is output to the ECN marking threshold table control unit 1603 through the packet receiving buffer control unit 1600. The ECN marking threshold table control unit 1603 controls reading of an ECN marking threshold table 1604 using the buffer number of the packet as a read address.

FIG. 18 shows one configuration example of an ECN marking threshold table 1604. The ECN marking threshold table 1604 includes ECN marking threshold values 16041 to 1604n of the buffer numbers. Upon reading of the ECN marking threshold table 1604 using the buffer number of the packet as a read address, the ECN marking threshold table control unit 1603 reads the ECN marking threshold value for the buffer number of a buffer accumulating the packet. The ECN marking threshold value is output to an ECN marking availability determining unit 1605 through the ECN marking threshold table control unit 1603. The ECN marking availability determining unit 1605 performs magnitude comparison between the number of accumulated packets in each buffer and the ECN marking threshold value. When the ECN marking threshold value<the number of accumulated packets in each buffer, it is determined that the ECN marking is to be executed. Information regarding execution availability of the ECN marking is output from the ECN marking availability determining unit 1605, and output to the packet receiving buffer control unit 1600 through the ECN marking threshold table control unit 1603.

At this time, a congestion state management table control unit 1606 for each buffer controls reading of a congestion state management table 1607 for each buffer, using the buffer number buffer number of a buffer accumulating the corresponding packet as a read address. The configuration of the congestion state management table 1607 for each buffer is the same as that of the congestion state management table (for each bandwidth monitoring entry) 541 of FIG. 12, except that the congestion state management table 1607 for each buffer has a congestion state flag in association with each buffer number, while the congestion state management table (for each bandwidth monitoring entry) 541 has a congestion state flag for each bandwidth monitoring entry. The congestion state management table control unit 1606 for each buffer controls writing of a congestion state flag for the buffer number of the buffer accumulating the data packet corresponding to the packet, into a value representing a congestion state.

In the packet receiving buffer control unit 1600, when it is determined that the packets input to the packet relay device 2 are data packets and the ECN marking should be executed, the packet receiving buffer control unit 1600 reads a value of the ECN field 10311 of the TOS field 1031, and rewrites it into “11” when the read value of the ECN field is “10” or “01”. The TOS field 1031 is included in the packet header information 1000 of the packets accumulated in the packet receiving buffer 1601 included in the packet receiving circuit 160. The rewriting is not performed when the read value of the ECN field 10311 is “00” or “11”.

When the packet input into the packet relay device 2 of this embodiment is an ACK packet of TCP, search activation for the flow search table 41 is performed by the flow search table control unit 40 of the flow search unit 140, under the condition that the source IP address and the destination IP address are exchanged from each other, and the source port number and the destination port number are exchanged. Then, the hit address of the flow search entry with the same data packet corresponding to the ACK packet is output from the flow search table 41 to the flow action table control unit 142 through the flow search table control unit 40. This hit address is used as a read address to control reading of the flow action table 143.

The buffer number of a buffer accumulating the data packet corresponding to the ACK packet is read. This buffer number is transmitted from the flow search unit 140 to the packet receiving circuit 160 through the flow action table control unit 142 and the flow search table control unit 40, and output to the congestion state management table control unit 1606 for each buffer through the packet receiving buffer control unit 1600. The congestion state management table control unit 1606 for each buffer controls reading of the congestion state management table 1607 for each buffer, using the buffer number of a buffer accumulating the data packet corresponding to the ACK packet as a read address.

A congestion stage flag for the buffer number of a buffer accumulating the data packets corresponding to the ACK packet is read by the congestion state management table control unit 1606 for each buffer, and is output to the packet receiving buffer control unit 1600 from the congestion state management table control unit 1606 for each buffer. In this case, if this congestion stage flag has a value representing a congestion stage, the value of the ECE field 10421 of the TCP flag field 1042 is rewritten into “1”. This TCP flag field 1042 is included in the packet header information 1000 of the corresponding packet accumulated in the packet receiving buffer 1601. As a result, the packet relay device 2 can perform the ECE marking for the ACK packet, instead of the receiving terminal 3, based on the congestion state of the packet receiving buffer 1601 in the packet relay device. Thus, congestion notification can be made along the route from the packet relay device to the receiving terminal, from the receiving terminal to the packet relay device, and from the packet relay device to the transmitting terminal. When the congestion state flag has a value representing that it is not in a congestion state, the ECE marking is not performed.

When the packet input to the packet relay device of this embodiment is a data packet DATA (CWR) (CWR=1), the congestion state management table control unit 1606 for each buffer rewrites the value of the congestion state flag of the congestion state management entry for each buffer into a value representing that it is not in a congestion state. This entry corresponds to a buffer to which the packet belongs, in the congestion state management table 1607 for each buffer. The ECE marking is not performed for the ACK packets that are received by the packet relay device thereafter.

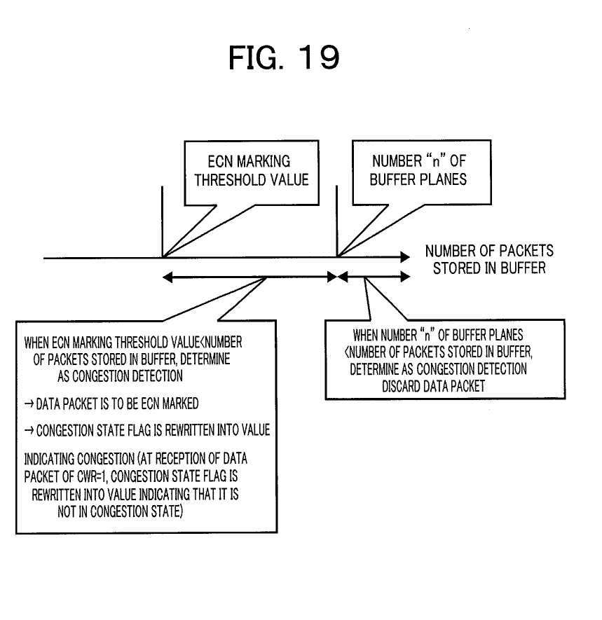

FIG. 19 schematically shows the relationship between the ECN marking threshold value and the number of packets accumulated in the buffer, in the buffer management of the packet receiving buffer 1601 with an “n” number of buffer planes, included in the packet receiving circuit 160 on the receiving side of the above-described embodiment.

The descriptions have so far been made of the configuration for detecting the congestion state and instructing congestion notification, in the buffer management of the packet receiving buffer 1601 included in the packet receiving circuit 160 on the receiving side. Similarly, the packet transmitting circuit 28 on the transmitting side of FIG. 2 can include the packet transmitting buffer. The configuration of this embodiment can be applied to the buffer management on the transmitting side. Particularly, buffer management on the transmitting side is called a “shaper” which enables to control the transmission bandwidth of the buffer.

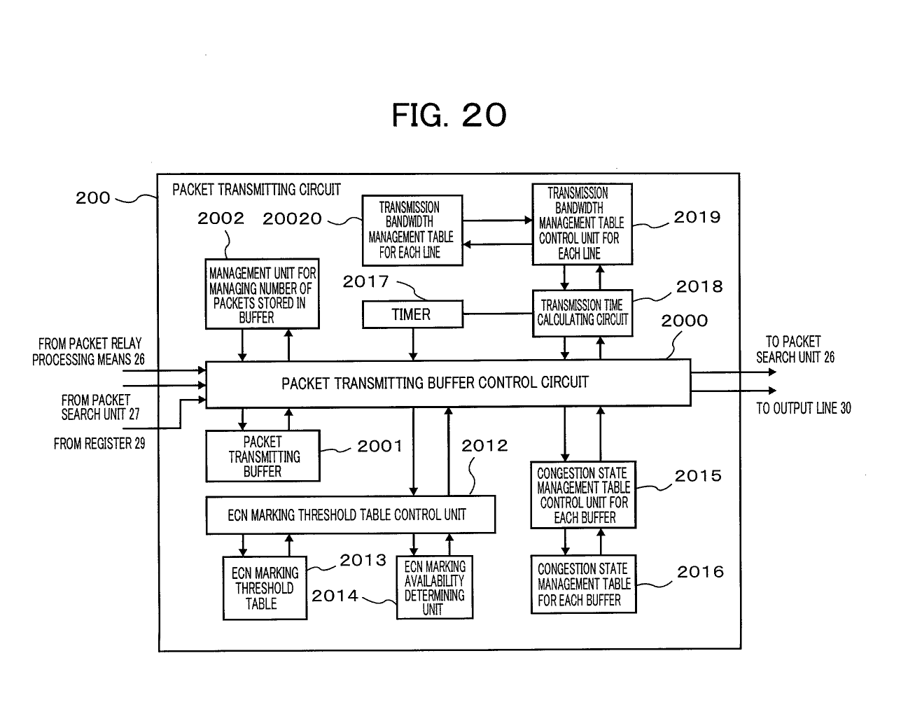

FIG. 20 shows one configuration example of a packet transmission circuit included in the shaper. The configuration of a packet transmitting circuit 2000 includes a timer 2017, a transmission time calculating circuit 2018, a transmission bandwidth management table control unit 2019 for each line, and a transmission bandwidth management table 2020 for each line, in addition to the configuration including a packet transmitting buffer 2001 and a packet transmitting buffer control unit 2000 respectively in place of the packet receiving buffer 1601 and the packet receiving buffer control unit 1600 in the packet receiving circuit 160 of FIG. 16. Unlike the packet receiving buffer 2011, the packet transmitting buffer 2001 is prepared for each line, instead of being prepared for each packet priority.

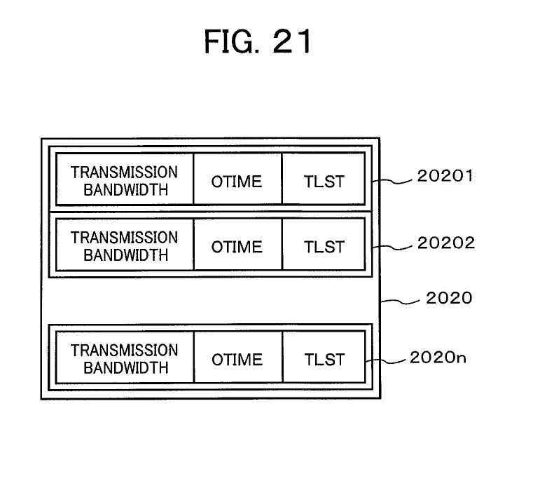

FIG. 21 shows one configuration example of the transmission bandwidth management table 2020 for each line. The transmission bandwidth management table 2020 for each line has a set value of a transmission bandwidth R for each of a plurality of output lines 30, a delay timer value 0TIME, and a last transmission timer value TLST, in each of the transmission bandwidth management entries (for each line) 20201 to 2020n. The last transmission timer value TLST is a timer value of the timer 2017 when the last packet transmission is performed. The set value of the transmission bandwidth R is determined in accordance with the line type of the output line 30 or the value of the transmission bandwidth that the operation manager of the packet relay device intends to assign for each output line 30. For the setting, the operation manager of the packet relay device inputs the set value of the transmission bandwidth R from the management terminal 19, and controls writing for the transmission bandwidth management table 2020 for each line from the transmission bandwidth management table control unit 2019 for each line through the register 29.

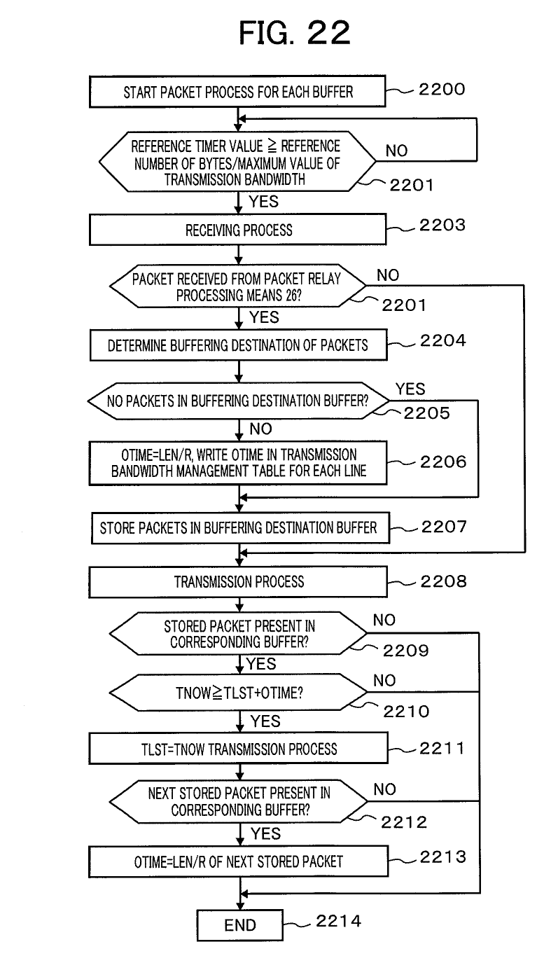

Descriptions will now be made of operations of the packet transmitting circuit of this embodiment, using the flowchart of FIG. 22. In the illustration, when a packet process of each buffer starts (2200), the packet transmitting buffer control unit 2000 of the packet transmitting circuit 200 determines whether the current timer value has reached a reference timer value, based on the timer value output by the timer 2017 (2201). The reference timer value represents a unit time that the packet transmitting circuit 200 executes a packet transmitting process or a packet receiving process. The reference timer value is calculated in accordance with the following Equation (1), based on the reference number of bytes of packets transmitted/received by the packet relay device 0 and the maximum value of the transmission bandwidth R.

Reference timer value [s]=reference number of bytes*8 [bit]/maximum value of transmission bandwidth R [bps] (1)

In this embodiment, [s] represents a timer value, rather than the second.

When it is determined that the current time value has reached the reference timer value, a receiving process and a transmitting process are executed (from 2202). When it is determined that the current timer value has not reached the reference timer value, a process for determining whether the current timer value has reached the reference timer value is looped. That is, in this embodiment, for each of the above-described reference timer value, the receiving process and the transmitting process are repeatedly executed.

Descriptions will now be made of the receiving process (2202). When the receiving process starts to be executed, it is determined whether a packet is received from the packet relay processing means 26 (2203). When the packet is received, the packet transmitting buffer control unit 2000 determines a buffering destination of the packet (2204). When no packet is received, the process shifts to a transmitting process (described later) (2208).

When the buffering destination of the packet is determined, the transmitting buffer control unit 2000 refers to the packet transmitting buffer 2001, and determines whether packet is accumulated in the packet transmitting buffer 2001 corresponding to the buffering destination (2205). When no packet is accumulated in the corresponding buffer, the transmission time calculating circuit 2018 calculates the time (delay timer value 0TIME) for delaying the packet transmission from the corresponding buffer. In this embodiment, the packet length LEN of the packets transmitted from the packet relay processing means 26 is divided by the transmission bandwidth R for each line, thereby calculating the delay timer value 0TIME (2206). The bandwidth transmission bandwidth R for each line can be obtained by reading the transmission bandwidth management table 2020 for each line, in accordance with the output line of the packets by the transmission bandwidth management table control unit 2019 for each line. This delay timer value 0TIME is calculated by the following Equation (2). According to Equation (2), the delay timer value 0TIME represents the earliest time that the packets can be transmitted at the next opportunity.

0TIME=LEN/R (2)

When the delay timer value 0TIME is calculated by the transmission time calculating circuit 2018, the value is written into the transmission bandwidth management entry (for each line) of the corresponding buffer in the transmission bandwidth management table 8-20 for each line, and the received packet is accumulated at the end of the corresponding buffer of the packet transmitting buffer 2001 by the packet transmitting buffer control unit 2000 (2207). When the packet is accumulated in a corresponding queue, the delay timer value 0TIME is not calculated, and the received packet is accumulated as it is at the end of the corresponding buffer of the packet transmitting buffer 2001. When the packet has already been accumulated, in the previous packet process for each buffer, the delay timer value 0TIME has already been calculated, and the delay timer value 0TIME is recorded in the transmission bandwidth management table 2020 for each line. Upon completion of the above receiving process, the transmitting process is subsequently executed (2208), and checks whether a packet is accumulated in the corresponding buffer (2209).

When the accumulated packet is checked, the transmission time calculation circuit 2018 compares the current timer value TNOW output from the timer 2017 with the scheduled transmission timer value which is obtained by adding the delay timer value 0TIME to the last transmission timer value TLST (2210).

There may exist a buffer which satisfies a condition that the current timer value TNOW coincides with the scheduled transmission timer value or a condition that the current timer value exceeds the scheduled transmission timer value. In this case, the buffer is a candidate for a target buffer (hereinafter referred to as “transmission target buffer”) to which the packets are transmitted. Based on the above condition, the transmission time calculating circuit 2018 determines whether there exists a transmission target buffer. When there does not exist the transmission target buffer, the corresponding transmitting process ends.

When there exists transmission target buffers, the transmission time calculating circuit 2018 specifies a buffer corresponding to the earliest scheduled transmission timer value, of the transmission target buffers. When the buffer corresponding to the earliest scheduled transmission timer value is specified, the packet transmitting buffer control unit 2000 transmits the packets from this buffer. Upon transmission of the packets, the transmission bandwidth management table control unit 2019 for each line updates the last transmission timer value TLST of a corresponding line in the transmission bandwidth management table 2020 for each line into the current timer value TNOW (2211).

Upon updating of the last transmission timer value TLSTb, subsequently, the packet transmitting buffer control unit 2000 determines whether there is a next accumulated packet in a buffer specified as a buffer corresponding to the earliest scheduled transmission timer value (2212). When there is no next accumulated packet, the corresponding transmitting process ends. When a next accumulated packet exists, the transmission time calculating circuit 2018 calculates a new delay timer value 0TIME regarding the buffer. This delay timer value DT is obtained by dividing the packet length LEN of the accumulated packet by the transmission bandwidth R of this line (2213). When a new delay timer value 0TIME is calculated, the transmission bandwidth management table control unit 2019 for each line writes this value into the entry of the corresponding line in the transmission bandwidth management table 2020 for each line.

The above-described ECN marking process in a series of shaper process is the same as the process by the packet receiving circuit 160. In the packet receiving process of the packet transmitting circuit 200 of FIG. 20, if buffering is performed, the number of packets accumulated in each packet-transmitting buffer is counted by a buffer accumulation packet number management unit 2002. The number of packets accumulated in each buffer, as counted by the packet accumulation packet number management unit 2002, is output to an ECN marking threshold table control unit 2012 through the packet transmitting buffer control unit 2000.

The ECN marking threshold table control unit 2012 controls reading of the ECN marking threshold table 2013. Upon reading of the ECN marking threshold table 2013, an ECN marking threshold value for a buffer in which the packet is accumulated is read. This ECN marking threshold value is output to an ECN marking availability determining unit 2014 through the ECN marking threshold table control unit 2012. The ECN marking availability determining unit 2014 determines and compares the magnitude of the number of packets accumulated in each buffer and the ECN marking threshold value. When a condition of “the ECN marking threshold value”<“the number of packets accumulated in each buffer” is satisfied, it is determined that the ECN marking is to be executed. Information representing whether ECN marking is executed is output from the ECN marking availability determining unit 2014, and output to the packet transmitting buffer control unit 2000 through the ENC marking threshold table control unit 2012.

In the packet transmitting buffer control unit 2000, when the packet is a data packet, and when it is determined that the ECN marking is to be executed, the packet transmitting buffer control unit 2000 reads the value of the ECN field 10311 of the TOS field 1031 in the packet header information 1000 of the packet accumulated in the packet transmitting buffer 2001 included in the packet transmitting circuit 200. When the value of the read ECN field is “10” or “01”, the value is rewritten into “11”. When the value of the read ECN field 10311 is “00” or “11”, the value is not rewritten.

When the packet is an ACK packet of TCP, search activation for the flow search table 41 is performed by the flow search table control unit 40 of the flow search unit 24 in the packet search unit 27 on the receiving side, under the condition that the source IP address and the destination IP address are exchanged from each other, and the source port number and the destination port number are exchanged. Then, the hit address of the flow search entry with the same data packet corresponding to the ACK packet is output from the flow search table 41 to the flow action table control unit 142 through the flow search table control unit 40. This hit address is used as a read address to control reading of the flow action table 143.

Then, the buffer number of a buffer accumulating the data packet corresponding to the ACK packet is read and transmitted to the packet transmitting circuit 200 from the flow search unit 24 through the flow action table control unit 142 and the flow search table control unit 40, and output to the congestion state management table control unit 2015 for each buffer through the packet transmitting buffer control unit 2000. The buffer number of a buffer accumulating the data packet corresponding to the ACK packet is used as a read address, to control reading of the congestion state management table 2016 for each buffer from the congestion state management table control unit 2015 for each buffer.

A congestion state flag for the buffer accumulating the data packet corresponding to the ACK packet is read by the congestion state management table control unit 2015 for each buffer, and output to the packet transmitting buffer control unit 2000 from the congestion state management table control unit 2015 for each buffer. When this congestion state flag has a value indicating that it is in a congestion state, the value of the ECE field 10421 of the TCP flag field 1042 is rewritten into “1”. The field 1042 is included in the packet header information 1000 of the corresponding packet accumulated in the packet transmitting buffer 2011. As a result, the ECE marking for the ACK packet can be performed by the packet relay device, instead of the receiving terminal, based on the congestion state of the packet transmitting buffer 2001 in the packet relay device. Thus, congestion notification can be made along the route from the packet relay device to the packet relay device through the receiving terminal, and from the packet relay device to the transmitting terminal. When the congestion state flag has a value indicating that it is not in a congestion state, the ECE marking is not performed.

When the corresponding packet is a data packet DATA (CWR) (CWR=1), the congestion state management table control unit 2015 for each buffer rewrites the value of a congestion state flag of a congestion state management entry for each buffer into a value representing that it is not in a congestion state. This congestion state management entry corresponds to a buffer to which the corresponding packet belongs, in the congestion state management table 2016 for each buffer. As a result, the ECE marking is not performed for the ACK packet received by the packet relay device thereafter.

Descriptions will be made briefly to an ECN process by the above-described packet relay device of this embodiment and communication with ECN between the transmitting terminal, the receiving terminal, and the packet relay device.

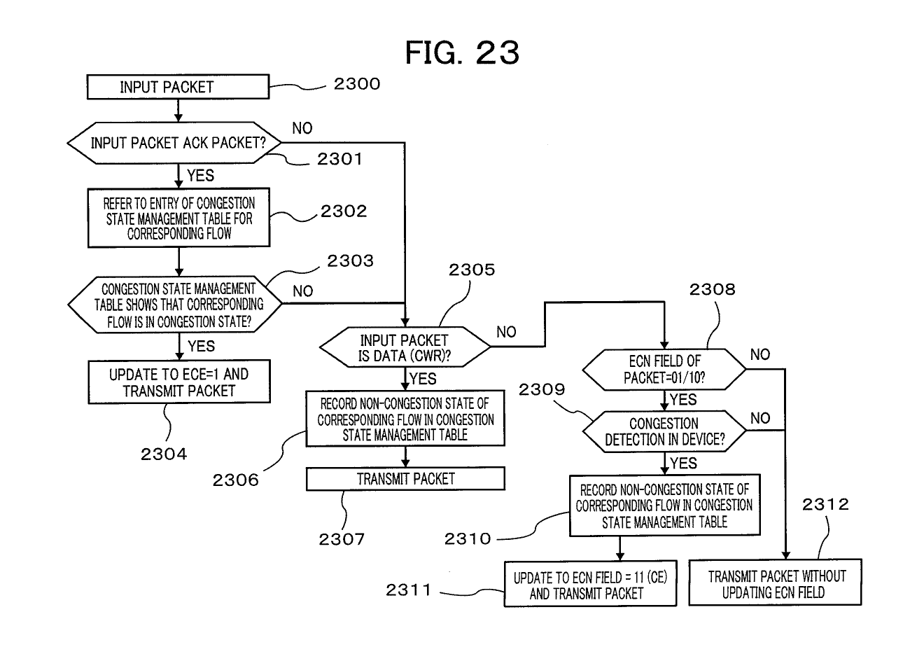

FIG. 23 shows a flowchart of communication by the packet relay device of this embodiment. As obvious from FIG. 23, a determination is as to whether an input packet is an ACK packet (2301). When the input packet is an ACK packet, the congestion state management entry of the congestion state management table for the corresponding flow is referred (2302). When it is in a congestion state (2303), a process for updating an ECE field of the corresponding ACK packet to “1” (2304) is added. When the input packet is DATA (CWR) (2305), a process for recording the non-congestion state of the corresponding flow into the congestion state management table (2306) is added. When the ECN field 11 is updated to “11” (2311), a process for recording the congestion state of the corresponding flow into the congestion state management table (2310) is added.

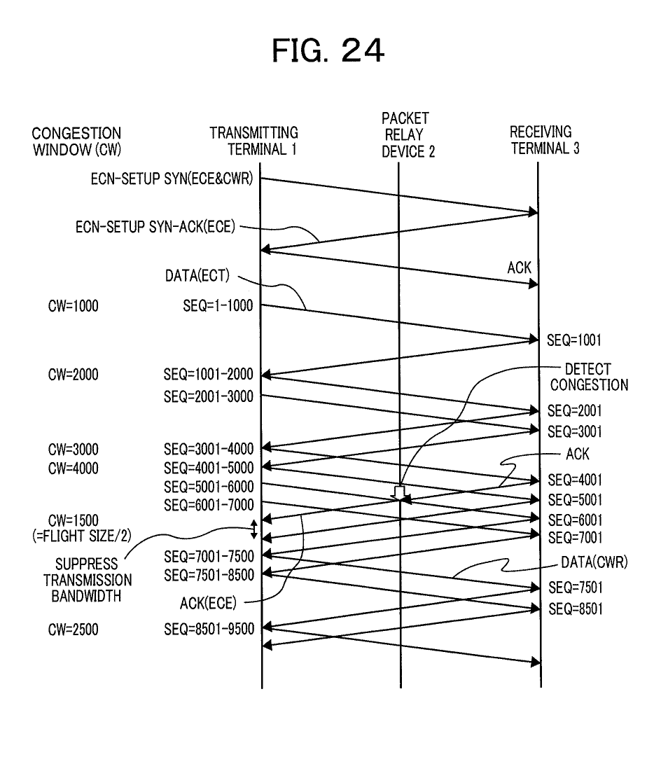

FIG. 24 shows a sequence diagram of communication using the packet relay device of this embodiment. Let it be assumed that a packet is transmitted/received between the transmitting terminal 1 and the receiving terminal 3 through the packet relay device 2 including, for example, a Router, or the like. In the communication regarding initialization of the ECN, first, an ECN-setup SYN packet is transmitted from the transmitting terminal 1 to the receiving terminal 3. This ECN-setup SYN packet has an ECE flag and a CWR flag as TCP control flags. This packet is to inform the receiving terminal 3 that the transmitting terminal is now to start ECN communication. Upon reception of the ECN-setup SYN packet, the receiving terminal 3 returns the ECN-setup SYN-ACK packet with the ECE flag to the transmitting terminal 1, when it supports the ECN. When the receiving terminal 3 does not support the ECN communication, it returns a SYN-ACK packet in the normal TCP 3 way handshake without an ECE flag, to the transmitting terminal 1. Thus, in accordance with the presence or absence of the ECE flag of the SYN-ACK packet, the transmitting terminal 1 can determine whether the receiving terminal 3 supports the ECN or not, and can determine whether ECN communication can be continued after that. The transmitting terminal 1 returns the ACK packet in the normal TCP 3 way handshake, to the receiving terminal 3. After that, data communication using the ECN starts. Like the normal TCP, the transmitting terminal 1 controls to increase the Congestion Window, when the ACK packet from the receiving terminal 3 is received by the transmitting terminal 1, that is, the terminal controls to increase the packet transmission bandwidth. The DATA (ECT) is an ECN-Capable-Transport data packet, that is, it is a data packet supporting the ECN, and is a packet with an ECN Field of “01” or “10”.

As described above, in the packet relay device 2 of this embodiment, if the packet relay device 2 detects the congestion, a process is added. This process is for rewriting the ACK (SEQ=4001) received by the packet relay device 2 into an ACK (ECE) by the packet relay device 2 thereafter. In the conventional configuration, the transmitting terminal 1 starts to control the congestion avoidance using the ACK (ECE) of SEQ=5001. However, as illustrated in FIG. 24, it is possible to start the congestion avoidance control using the ACK (ECE) of SEQ=4001. This implies that congestion avoidance control is performed at as early a stage as that much.

As a result, in the conventional ECN sequence, congestion notification is too late, and thus the DATA (ECT) of SEQ=7001-8000 is transmitted using the ACK of SEQ=4001. The DATA (ECT) of SEQ=7001-8000 is transmitted during the congestion in the packet relay device 2, thus getting worse in the congestion and being discarded in the packet relay device 2. When duplicate ACK or a time-out for the discarded DATA (ECT) of SEQ=7001-8000 is detected by the transmitting terminal 1, the transmitting terminal 1 retransmits the DATA (ECT) of SEQ=7001-8000, thus excessively consuming the bandwidth between the transmitting terminal 1 and the packet relay device 1. This results in decreasing the substantial throughput.

In the packet relay device 2 of this embodiment, as illustrated in FIG. 24, congestion notification can be made at the early stage using the ACK (ECE) of SEQ=4001. Thus, it is possible to delay the transmission of the DATA (ECT) of SEQ=7001-8000. As a result, the transmitting terminal 1 can suppress excess packet transmission during the congestion, thus preventing the throughput decrease due to retransmission of the packet. This effect is remarkable as the delay increases between the packet relay device 2 and the receiving terminal 3. The congestion notification can be made earlier than that in the conventional ECN, congestion avoidance control. Therefore, the packet retransmission can be suppressed more, thus effectively preventing degradation of the throughput. The transmitting terminal 1 receives the ACK (ECE) of SEQ=4001, and the Congestion Window is reduced to control the congestion avoidance for suppressing the transmission bandwidth. After this, DATA (CWR) of SEQ=7001-8000 is transmitted to the receiving terminal 3. The DATA (CWR) is a data packet representing that the congestion avoidance control is executed by the transmitting terminal 1 upon Congestion Window Reduction. After the relay device receives DATA (CWR), it rewrites the congestion state flag for the flow with the same packet into a value representing that it is not in a congestion state, in the congestion state management flag of the relay device. After the receiving terminal 3 receives DATA (CWR), the receiving terminal 3 stops transmitting the ACK (ECE), and transmits an ACK packet without an ECE flag thereafter.

After the transmitting terminal 1 receives the ACK (ECE), the transmitting terminal 1 reduces the Congestion Window to control the congestion avoidance for suppressing the transmission bandwidth, and transmits DATA (CWR) to the receiving terminal 3. DATA (CWR) is a data packet which represents that the control for congestion avoidance is made by the transmitting terminal 1 upon Congestion Window Reduction. After the receiving terminal 3 receives the DATA (CWR), the receiving terminal 3 stops transmitting the ACK (ECE), and transmits an ACK packet without an ECE flag.

The congestion detecting process may be executed at packet reception, or may be regularly executed.

As specifically described above, according to the packet relay device of the embodiment 1, the congestion notification can be made at an early stage. Thus, the transmitting terminal can suppress excess packet transmission in the congestion, thus preventing degradation of the throughput due to packet retransmission. This effect is remarkable, as the delay increases between the packet relay device and the receiving terminal. Thus, the congestion notification can be made earlier than the case of the conventional ECN, to control congestion avoidance. Therefore, the packet retransmission can be suppressed more, thus effectively preventing degradation of the throughput.

### Embodiment 2

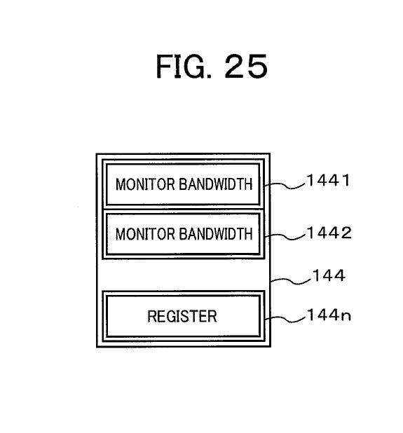

Descriptions will now be made of a packet relay device of the second embodiment, using FIG. 25. In the descriptions of the embodiment 2, only the differences from the embodiment 1 will be focused. The descriptions of the embodiment 2 will be made of a configuration, in which packet header information of a packet to be input to the packet relay device is autonomously collected in the packet relay device, and a condition of flow is autonomously registered in the flow search table 41 in the packet relay device, based on the packet header information of the input packet. In this configuration, the operation manager of the packet relay device does not need to set the flow condition in advance. This enables autonomous relay of the input packet. Further, descriptions will be made of a configuration in which the operation manager of the packet relay device can specify target flow to be autonomously registered in the packet relay device. It will be possible for the operation manager of the packet relay device to efficiency specify target flow, under the physical resource constraints of the flow search table 41 or the congestion state management table. Descriptions will hereinafter be made of the congestion detection as a result of bandwidth monitoring. However, like the embodiment 1, the configuration of this embodiment can be applied to congestion detection using a buffer or shaper. That is, it is possible to determine that the flow is in a congestion state based on the queue length in the shaper or the “bucket water amount” in policer as a determination reference, in place of whether the number of packets accumulated in the buffer exceeds a predetermined threshold value.

In the embodiment 2, a condition of target flow to be registered is set in the flow search entry 418-a in the lowermost address of the flow search table 41 illustrated in FIG. 8. Like the flow search entry 418-a of the illustration, if “d.c.” is set in the entire flow conditions of the target flow search entry to be registered, the bandwidth monitoring is performed for a target arbitrary flow to be registered, thereby managing the congestion state of the arbitrary flow.

Like a flow search entry 417-a, if a condition of a target flow to be registered is specified, the bandwidth monitoring is performed for the specified flow as a target to be registered, and thus managing the congestion state of only the specified flow. The specified flow for managing the congestion state is indicated by the operation manager of the packet relay device in advance. The capacity of each of the flow search table 41 and the congestion state management table is constrained as limited physical resources. Thus, the operation manager of the packet relay device specifies the number of flows, in accordance with the constraints. When there are a plurality of conditions of flow to be registered, it is possible to set the conditions of target flows to be registered in the plurality of flow search entries.

Set in the flow search table 41 of the flow search unit 140 in the embodiment 2 are a flow search entry for registration as a flow search entry specifying a target flow to be registered and a flow search entry for bandwidth monitoring as a flow search entry for referring to the bandwidth monitoring entry described in the embodiment 1. To distinguish the two kinds of flow search entries, like the flow search unit 140 of the embodiment 1, the flow search unit of the embodiment 2 also includes a flow action table control unit and a flow action table. Note that the configuration of the flow action table 144 differs from that of the flow action table 143 of FIG. 15 in the embodiment 1, and has a configuration of the flow action table 144 of FIG. 25.

As illustrated in FIG. 25, the flow action table 144 of this embodiment has a configuration having information representing whether the flow search entry is a registered flow search entry or a bandwidth monitoring flow search entry, instead of the information regarding the buffer number as illustrated in FIG. 15. In the illustration, flow action entries 1441 and 1442 described as “monitor bandwidth” are set corresponding to the flow search entries for bandwidth monitoring, while a flow action entry 144n described as “register” is set corresponding to the flow search entry for registration.

Upon input of information regarding a condition of target flow to be registered of this embodiment which is specified by the operation manager of the packet relay device 2, from the management terminal 19, the input value is input into the flow search table control unit 40 of the flow search unit 140 through the register 29. Then, the flow search table control unit 40 controls writing for the flow search table 41, thereby setting a flow search entry for flow registration in the flow search table 41.

Upon input of a packet to the packet relay device 2 of this embodiment, the flow action table control unit 142 determines that the input packet coincides with the flow search entry for registration, when packet header information of this packet coincides with the flow condition described in the flow search entry of the flow search table 41, and when information specifying “register” is written in the flow action entry of the flow action table 144 as read by the flow action table control unit 142 using an address of the corresponding flow search entry as a read address. Then, information representing the coinciding of the flow search entry for registration and the packet header information of the input packet are transmitted to the register 29 through the flow search table control 40, and then transmitted to the management terminal 19.

The management terminal 19 analyzes the transmitted packet header information 1000, and transmits information for instructing to set the flow condition based on this packet header information 1000 in the flow search table 41 as a flow search entry for bandwidth monitoring, to the flow search table control unit 40 through the register 29. The flow search table control unit 40 sets and controls writing of the packet header information in the flow search table 41 as a flow search entry, based on the information. Using the same address as that of the corresponding flow search entry as a write address, the flow action table control unit 142 controls writing of information for instructing “monitor bandwidth” in the flow action entry of the flow action table 144. Further, it transmits information (parameters R510, THR 513, and THRM 514 of FIG. 10) regarding the bandwidth monitoring specified in advance by the operation manager of the packet relay device, to the bandwidth monitoring table control unit 50 through the register 29. The bandwidth monitoring table control unit 50 controls writing of the information (R510, THR513, and THRM514) into the area monitoring entry of the bandwidth monitoring table 51, using the same address as that of the corresponding flow search entry as a write address.

According to the above-described processes of the embodiment 2, the packet header information of the packet input to the packet relay device is autonomously collected by the packet relay device, and the packet relay device realizes a process for registering the flow condition autonomously into the flow search table based on the packet header information of the input packet.

### Embodiment 3

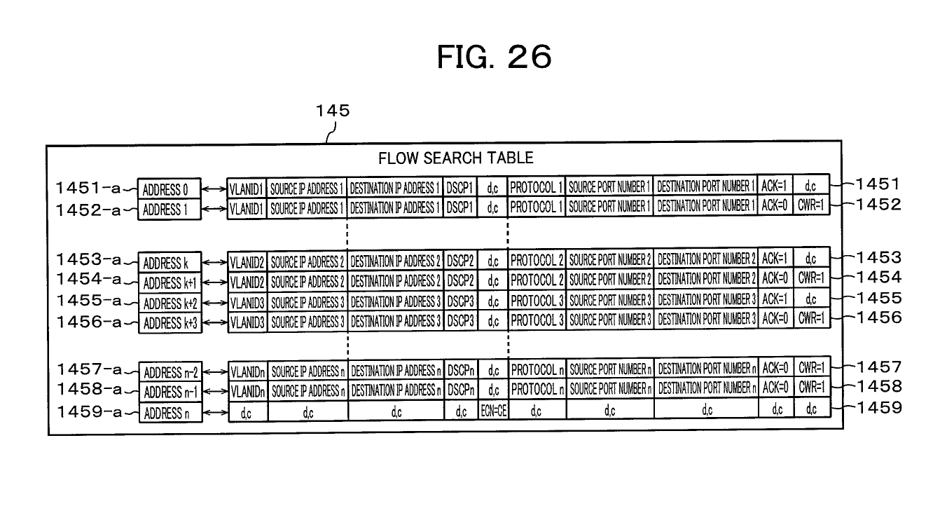

Subsequently, in a third embodiment, descriptions will now be made of an embodiment of a configuration in which a packet relay device, located upstream and without the configuration of the present invention, performs ECE marking for an ACK packet of an ECN marked packet, upon reception of this packet, using FIG. 26 to FIG. 29. In the descriptions of the embodiment 3, only the differences from the embodiment 2 will be focused.

In this embodiment, upon detection of the ECN marked packet by the packet relay device located upstream and without the configuration of the present invention, a “flow search entry for cooperation registration with upstream device” for registration in the flow search table is registered to an address right above the flow search entry for registration in the embodiment 2, based on specification of the operation manager of the packet relay device. Further, the “flow search entry for cooperation ECE marking with the upstream device” registered based on the “flow search entry for cooperation registration with upstream device” and the “flow search entry for canceling cooperation with upstream device” are autonomously registered in the packet relay device to an higher rank address than that of the “flow search entry for cooperation registration with upstream device”.

FIG. 26 shows a configuration of a flow search table 145 of this embodiment, with the omission of the flow search entry for bandwidth monitoring and the flow search entry for registration. The flow search table 145 differs from the flow search table 41 in a point that the TOS field is divided and set into a DSCP field and an ECN field. Numerals 1451, 1453, 1455, and 1457 correspond to “flow search entries for cooperation ECE marking with upstream device”, while numerals 1452, 1454, 1456, and 1458 correspond to “flow search entries for canceling cooperation with upstream device”, and a numeral 1459 corresponds to “a flow search entry for cooperation registration with upstream device”. The entries 1451 and 1452, 1453 and 1454, 1455 and 1456, 1457 and 1458 are flow search entries in pairs, and are autonomously registered by the packet relay device 2 of this embodiment. They have the coinciding items in the entire flow conditions, except that ACK=1 in the “flow search entries for cooperation ECE marking with upstream device” and that ACK=0 and CWR=1 in the “flow search entries for canceling cooperation with upstream device”.

In the flow search entry for registration described in the embodiment 2, ECN field=d.c., and packet detection is performed regardless of whether the congestion has been detected by the upstream packet relay device. On the contrary, in the flow search entry 1459 for cooperation registration with upstream device, ECN field=CE, and only the congestion detected packet is detected by the upstream packet relay device. In addition, in the flow search entry for bandwidth monitoring described in the embodiment 2, a packet header value of an input packet is registered into the ECN field as the low two bits of the TOS field. On the contrary, in the flow search entries 1451, 1453, 1455, and 1457 for cooperation ECN marking with upstream device and in the flow search entries 1452, 1454, 1456, and 1458 for canceling cooperation with upstream device, ECN field=d.c. Another difference is even when the ECN field=CE in the input packet at the registration, a packet (ECN≠CE) is detected in the flow search entries for cooperation ECN marking with upstream device.

Under the ECN's rules, if the receiving terminal receives a packet (ECN=CE), there is a process for continuously transmitting an ACK packet (ECE=1) even when the packet (ECN≠CE) has been received, until a packet (CWR=1) is received thereafter. When the packet relay device of this embodiment receives a packet (ECN=CE), the received ACK packet with the ECE is rewritten into “1” and kept transmitted, even the packet (ECN≠CE) is received, until the packet (CWR=1) is received thereafter.

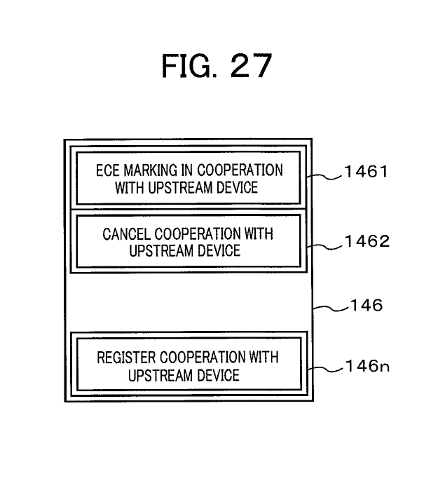

FIG. 27 shows a configuration of a flow action table 146 of this embodiment with the omission of the flow action entry corresponding to the flow search entry for bandwidth monitoring in the embodiment 2 and the flow action entry corresponding to the flow search entry for registration. In the flow action table 146, information for instructing “cooperation ECE marking with upstream device” is written into a flow action entry 1461 corresponding to the flow search entry for cooperation ECE marking with upstream device, information for instructing “canceling cooperation with upstream device” is written into a flow action entry 1462 corresponding to the flow search entry for canceling cooperation with upstream device, and information for instructing “cooperation registration with upstream device” is written into a flow action entry 146n corresponding to the flow search entry for cooperation registration with upstream device.

A packet (ECN=CE), which has been ECN marked by a packet relay device located upstream and without the configuration of the present invention, is input to the packet relay device of the present invention. In this case, the packet header information of this packet coincides with the flow condition written into the flow search entry 1459 for cooperation registration with upstream device, registered in response to the instruction of the operation manager of the packet relay device in advance, in the flow search table 145. When information for instructing for “cooperation registration with upstream device” is written into a flow action entry of the flow action table 146, read by the flow action table control unit 142, using an address of the flow search entry 1459 for cooperation registration with upstream device as a read address, the flow action table control unit 142 determines that the input packet is one coinciding with the flow search entry for cooperation registration with upstream device.

Information representing the coinciding of the flow search entry for cooperation registration with upstream device and the packet header information of the input packet are transmitted to the register 29 through the flow search table control unit 40, and are transmitted to the management terminal 19. The management terminal 19 analyzes the transmitted packet header information, and transmits instruction information to the flow search table control unit 40 through the register 29. This instruction information is to instruct for setting a flow condition based on the packet header information into the flow search table 41, as a flow search entry for cooperation ECE marking with upstream device and a flow search entry for canceling cooperation with upstream device. At this time, “d.c.” is registered in the ECN field of the flow search entry for cooperation ECE marking with upstream device and the flow search entry for canceling cooperation with upstream device. A flow search entry for cooperation ECE marking with upstream device and a flow search entry for canceling cooperation with upstream device are written into the flow search table 41 in accordance with the information, thereby setting the packet header information. The flow action table control unit 142 controls writing of information for instructing “cooperation ECE marking with upstream device” into the flow action entry of the flow action table 146, using the same address as the address of the flow search entry for cooperation ECE marking with upstream device as a write address. The flow action table control unit 142 controls writing of information for instructing “canceling cooperation with upstream device” into the flow action entry of the flow action table 146, using the same address as the address of the flow search entry for canceling cooperation with upstream device as a write address.

Descriptions will now be made of a process in a case where an ACK packet of TCP is input to a packet relay device of the embodiment 3. When an ACK packet of TCP is input to the packet relay device of this embodiment, the packet header conditions are exchanged between a source IP address and a destination IP address of the packet header information, and between a source port number and a destination port number. Then, search activation for the flow search table 41 is performed by the flow search table control unit 40. As a result of the search, for a flow condition registered as a flow search entry for cooperation ECE marking with upstream device, a packet having the same packet header information may be input to the packet relay device of this embodiment after exchanging the packet header conditions. In this case, if information for instructing “cooperation ECE marking with upstream device” is described in a flow action entry of the flow action table 146 read by the flow action table control unit 42, using the address of the coinciding flow search entry for cooperation ECE marking with upstream device in the flow search table 145, the flow action table control unit 142 determines that the input packet coincides with the flow search entry for cooperation ECE marking with upstream device, and information representing the coinciding of the flow search entry for cooperation ECE marking with upstream device is transmitted to the packet receiving circuit 21 through the flow search table control unit 40. Then, the packet receiving buffer control unit 210 controls reading of the packet header information 1000 of this ACK packet from the packet receiving buffer 211, and rewrites the value of the ECE field 10421 of the TCP flag field 1042 in this packet header information 1000 into “1”. It will now be possible to perform the ECE marking for the ACK packet by the packet relay device, instead of the receiving terminal, based on the congestion state of the packet receiving buffer 211 of the packet relay device. Therefore, congestion notification can be made along the route from the packet relay device to the receiving terminal, from the receiving terminal to the packet relay device, and from the packet relay device to the transmitting terminal. When the corresponding ACK packet does not coincide with the flow search entry for cooperation ECE marking with upstream device, the ECE marking process is not performed. In the ACK packet, ACK=1, thus it does not coincide with the flow search entry for canceling cooperation with upstream device, in which ACK=0 and CWR=1.

When a data packet of CWR=1 is input to the packet relay device of the embodiment 3, search activation for the flow search table 41 is performed by the flow search table control unit 40 without exchanging the above-described packet header conditions. As a result of the search, when the packet header information 1000 of the corresponding data packet coincides with the flow condition of the flow search entry for canceling cooperation with upstream device, the flow search control unit 40 controls deleting of the coinciding flow search entry for canceling cooperation with upstream device and the flow search entry for cooperation ECE marking with upstream device which has been registered with the corresponding entry in a pair. Next, it deletes information for instructing “canceling cooperation with upstream device” of a flow action entry of the flow action table 143 with the same address as the address of the coinciding flow search entry for canceling cooperation with upstream device. It also deletes information for instructing “cooperation ECE marking with upstream device” of the flow action entry in the flow action table 143 with the same address as the address of the flow search entry for cooperation ECE marking with upstream device registered with the corresponding entry in a pair.

Descriptions will now be made of a flowchart including the above-described process of the packet relay device of the embodiment 3, and to a sequence diagram briefly including communication performed between the transmitting terminal, the receiving terminal, and the packet relay device.

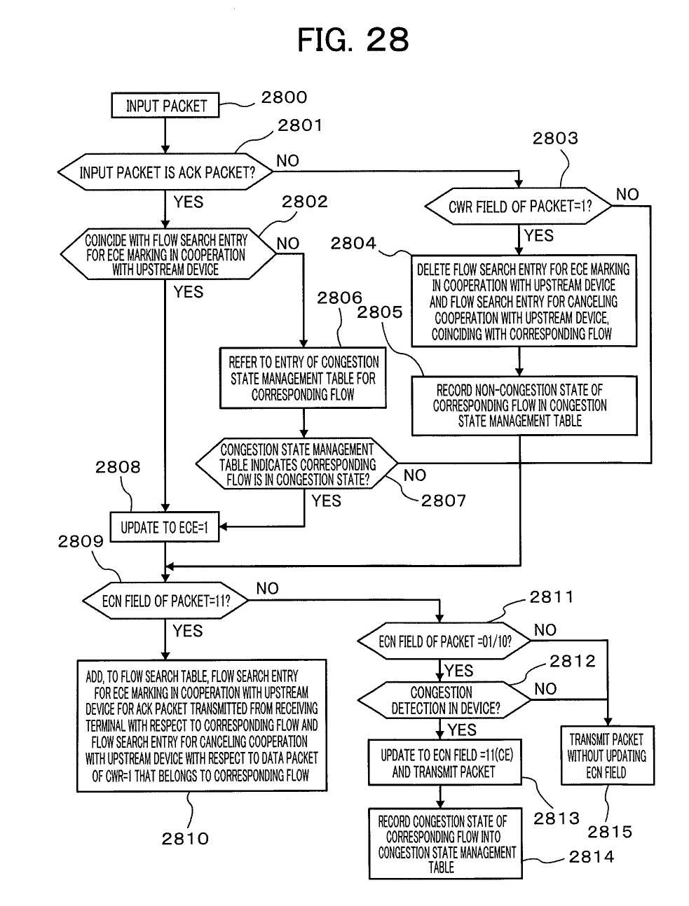

FIG. 28 shows a flowchart of a process performed by the packet relay device of the embodiment 3. In this embodiment, in addition to the process of the flowchart in the embodiment 1 illustrated in FIG. 23, a determination is made as to whether the ECN field of an input packet is “11”, that is “CE”. When the ECN field of the input packet is not “11”, like the embodiment 1, the process shifts to a process for determining congestion detection in the packet relay device. When the ECN field of the input packet is “11”, a characteristic process of the embodiment 3 is performed. Specifically, the packet header conditions of the packet header information 1000 of the packet are exchanged, and some entries are added into the flow search table. The entries include a flow search entry for cooperation ECE marking with upstream device for an ACK packet transmitted from the receiving terminal for the flow of the packet and a flow search entry for canceling cooperation with upstream device for a data packet of CWR=1 in the flow of the packet.

In this embodiment, when the input packet is an ACK packet, a determination is made as to whether the corresponding ACK packet coincides with the flow search entry for cooperation ECE marking with upstream device. When the ACK packet coincides with the entry, a process for performing ECE marking is added. When the ACK packet does not coincide with the entry, like the embodiment 1, the congestion state management table for the corresponding flow is referred. When the flow is in a congestion state, the ECE marking is performed.

In this embodiment, when the input packet is not an ACK packet, that is, it is a data packet, and CWR=1, some processes are added. One process is performed for deleting a flow search entry for cooperation ECE marking with upstream device with the coinciding packet header information of the packet in the flow and a flow search entry for canceling cooperation with upstream device with the coinciding packet header information of the packet in the flow. Another process is performed for recording a non-congestion state of the flow into the congestion state management table.

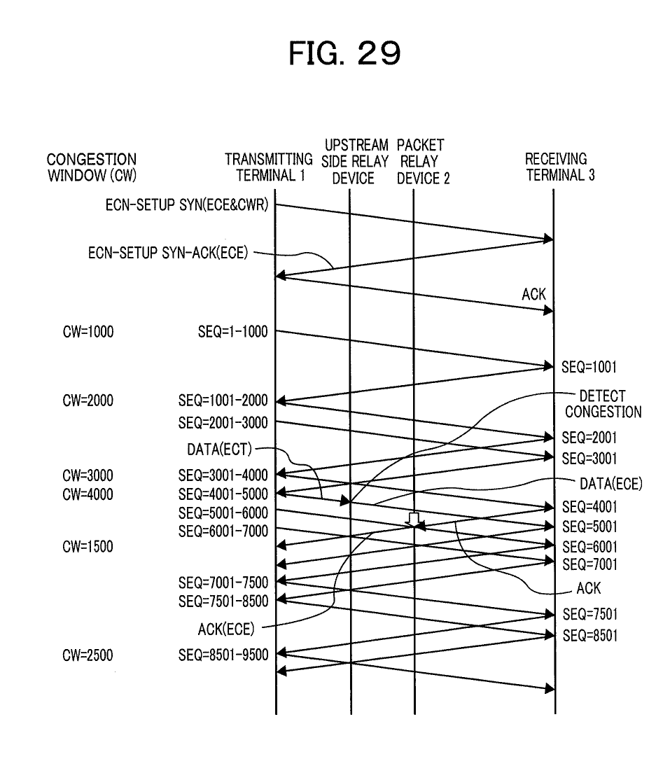

FIG. 29 shows a sequence diagram of communication using the packet relay device of the embodiment 3. In the sequence diagram of this embodiment, an upstream relay device (upstream Router) is provided, in addition to the transmitting terminal 1, the packet relay device 2, and the receiving terminal 3, as communication constituent elements of sequence diagram 24. The upstream relay device is located upstream of the packet relay device 2, and does not have the configuration of this embodiment. The packet relay device 2 receives DATA (ECE) as a packet of SEQ=4001-5000 after ECE marked by the upstream relay device, thereby detecting congestion in the upstream relay device. Upon detection of this, it performs ECE marking for an ACK packet (that is, ACK packet from SEQ=4001) for the corresponding packet received thereafter. As a result, upon reception of the packet which has been ECN marked by the packet relay device without a functional configuration of the present invention, located upstream, the packet relay device 2 realizes ECE marking for the ACK packet for the corresponding packet, and transmits it to the transmitting terminal 1.

### Embodiment 4

Descriptions will now be made of the packet relay device of the embodiment 4. In the descriptions below, only those characteristic processes of the embodiment 4 will be focused. In the embodiment 4, descriptions will be made of a configuration in which the packet relay device acts as a substitute for performing the entire processes, including an initialization process with TCP 3 way handshake and the entire processes regarding the ECN in the receiving terminal. With this configuration, even when the receiving terminal does not support the ECN, it is possible to make communication between the transmitting terminal and the packet relay device, with ECN support. The packet relay device of this embodiment performs a concealing process of rewriting DATA (ECT) as a data packet with ECN support or a data packet DATA (CWR) representing that congestion avoidance has already been controlled in the ECN, into a data packet DATA (not-ECT) with ECN non-support. This prevents ECN communication for the receiving terminal.

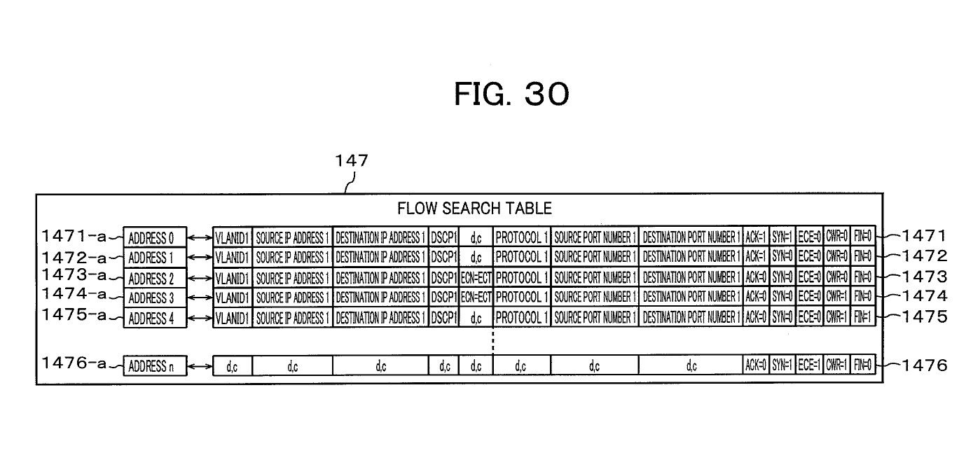

FIG. 30 shows a configuration of a flow search table of this embodiment. Unlike the flow search table 145, a flow search table 147 has a SYN field and an ECE field. A numeral 1471 corresponds to a flow search entry for SYN-ACK packet detection, a numeral 1472 corresponds to a flow search entry for ACK packet detection, a numeral 11473 corresponds to a flow search entry for DATA (ECT) packet detection, a numeral 1474 corresponds to a flow search entry for DATA (CWR) packet detection, a numeral 1475 corresponds to a flow search entry for FIN packet detection, and a numeral 1476 corresponds to a flow search entry for ECN-setup SYN packet detection. The entries 1471 to 1475 are autonomously registered by the packet relay device of this embodiment, as a set of flow search entries, and have the coinciding items in the entire flow conditions, except the TCP flag field and the ECN field including ACK, SYN, ECE, CEW, FIN fields. The flow search entry 1476 for ECN-setup SYN packet detection is to detect an ECN-setup SYN packet, in which an arbitrary ACK=0, SYN=1, ECE=1, and CWR=1.

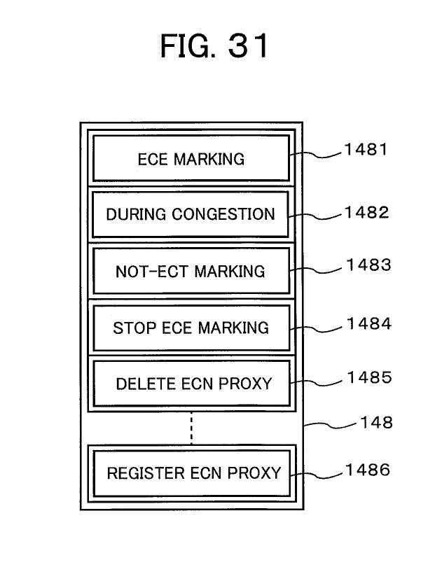

FIG. 31 shows a configuration of a flow action table 148 corresponding to the above-described flow search entry in the embodiment 4. In the flow action table 148, information for instructing “ECE marking” is written into a flow action entry 1481 corresponding to the flow search entry 1471 for SYN-ACK packet detection. This instruction is to rewrite a SYN-ACK packet with ECN non-support (that is, SYN-ACK packet in which ECE=0) which is transmitted by a receiving terminal not supporting the ECN into a SYN-ACK packet with ECN support (that is, SYN-ACK packet in which ECE=1), by the packet relay device of the embodiment 4.

Information for instructing “ECE marking in congestion” is written into a flow action entry 1482 corresponding to the flow search entry 1472 for ACK packet detection. This is to instruct the ECE marking in the packet relay device of this embodiment, for an ACK packet detected in the flow search entry 1472 for ACK packet detection, upon detection of congestion in the packet relay device, until a data packet of CWR=1 is detected thereafter.

Information for instructing “not-ECT marking” is written into a flow action entry 1483 corresponding to the flow search entry 1473 for DATA (ECT) packet detection. This instruction is to rewrite a DATA (ECT) packet (that is, a data packet in which ECN field=“01”, “10”, or “11”) checked and detected in the flow search entry for DATA (ECT) packet detection 1473 into a DATA (not-ECT) packet (that is, a data packet in which ECN field=“00”), in the packet relay device of this embodiment.

Information for instructing “ECE marking stoppage & not-ECT marking” is written into a flow action entry 1484 corresponding to the flow search entry 1474 for DATA (CWR) packet detection. This instruction is to rewrite a DATA (CWR) packet (that is, a data packet in which CWR=1) detected in the flow search entry 1474 for DATA (CWR) packet detection, into a DATA (not-ECT) packet (that is, a data packet in which ECN field=“00” and CWR=0), in the packet relay device of this embodiment, and to rewrite the congestion state management entry in the congestion state management table into a value representing that it is not in a congestion state. As a result, it instructs to stop the ECE marking for the ACK packet thereafter.

Information for instructing “delete ECN proxy” is written into a flow action entry 1485 corresponding to the flow search entry 1475 for FIN packet detection. This instruction is to delete the flow search entry 1471 for SYN-ACK packet detection (for detecting a SYN-ACK packet belonging to the flow searched in the flow search entry 1476 for ECN-setup SYN packet detection), the flow search entry 1473 for DATA (ECT) packet detection and for data packet detection, the flow search entry 1474 for DATA (CWR) packet detection, the flow search entry 1472 for ACK packet detection and for detecting the ACK packet, and the flow search entry 1475 for FIN packet detection and for detecting the FIN packet, from the flow search table 147. In addition, the instruction is to delete the flow action entries 1481 to 1485 corresponding to these flow search entries from the flow action table 148, and to stop the ECN proxy process including the initialization process with the TCP 3 way handshake thereafter.

Information for instructing “register ECN proxy” is written into a flow action entry 1486 corresponding to the flow search entry 1476 for ECN-setup SYN packet detection. This instruction is to register, into the flow search table 147, the flow search entry 1471 for SYN-ACK packet detection and for detecting the SYN-ACK packet belonging to the flow searched in the flow search entry 1476 for ECN-setup SYN packet detection, the flow search entry 1473 for DATA (ECT) packet detection and for detecting the data packet, the flow search entry 1474 for DATA (CWR) packet detection, the flow search entry 1472 for ACK packet detection and for detecting the ACK packet, and the flow search entry 1475 for FIN packet detection and for detecting the FIN packet. Further, the instruction is to register the flow action entries 1481 to 1485 corresponding to the flow search entries into the flow action table 148.

Descriptions will now be made specifically to the processes.

When an ECN-setup SYN packet (ACK=0, SYN=1, ECE=1, CWR=1, and FIN=0) is input to the packet relay device of this embodiment, search activation control is performed by inputting the packet header information 1000 from the flow search table control unit 40 of the flow search unit 140 to the flow search table 147. As a result of the search, an address 1476-a of the flow search entry 1476 for ECN-setup SYN packet detection coinciding with the packet header information 1000 of the corresponding packet is output from the flow search table 147. Then, this address 1476-a is input to the flow action table control unit 42, and the flow action table 143 is controlled to be read, using the address 1476-a as a read address. Then, the flow action entry 1486 in which the information for instructing “register ECN proxy” is written in advance is read out. This information representing “register ECN proxy” and the packet header information 1000 are transmitted to the management terminal 19 through the register 29. The management terminal 19 analyzes the transmitted packet header information 1000, and transmits instruction information to the flow search table control unit 40 through the register 10. This instruction information is to instruct to set the flow condition into the flow search table 147 as a flow search entry for bandwidth monitoring, based on the packet header information 1000. The management terminal 19 analyzes the transmitted packet header information 1000, and transmits instruction information to the flow search table control unit 40 through the register 29. This instruction information is an instruction for setting the flow condition(s) based on the packet header information 1000 into the flow search table 147, as the flow search entry 1471 for SYN-ACK packet detection, the flow search entry 1472 for ACK packet detection, the flow search entry 1473 for DATA (ECT) packet detection, and the flow search entry 1474 for DATA (CWR) packet detection.

The flow search table control unit 40 controls writing of the flow search entry 1471 for SYN-ACK packet detection, the flow search entry 1472 for ACK packet detection, the flow search entry 1473 for DATA ECT) packet detection, the flow search entry 1474 for DATA (CWR) packet detection, and the flow search entry 1475 for FIN packet detection, into the flow search table 147. In fact, DATA (ECT) and DATA (CWR) include three entries of ECN=01, 10, or 11, not based on the ECN field value of the input packet. The flow action entry 1483 corresponding to the DATA (ECT) also includes three entries (ECN=01, 10, or 11) corresponding to three flow search entries 1473 for DATA (ECT) packet detection. The flow action entry 1484 corresponding to the DATA (CWR) also includes three entries corresponding to the three flow search entries 1474 (ECN=01, 10, or 11) for DATA (CWR) packet detection.

As illustrated in FIG. 30, in the flow search entry 1471 for SYN-ACK packet detection, the flow condition based on the packet header information 1000 is set with ACK=1, SYN=1, ECE=0, CWR=0, and FIN=0 not based on the packet header information 1000. In the flow search entry 1472 for ACK packet detection, the flow condition based on the packet header information 1000 is set with ACK=1, SYN=0, ECE=0, CWR=0, and FIN=0 not based on the packet header information 1000. In the flow search entry 1473 for packet detection, the flow condition based on the packet header information 1000 is set with ACK=1, SYN=0, ECE=0, CWR=0, and FIN=0 not based on the packet header information 1000. In addition, three entries of ECN=01, ECN=10, and ECN=11 are set not based on the packet header information 1000. In the flow search entry 1474 for DATA (CWR) packet detection, the flow condition based on the packet header information 1000 is set with ACK=0, SYN=0, ECE=0, CWR=1, and FIN=0 not based on the packet header information 1000, and three entries of ECN=01, ECN=10, and ECN=11 are based on the packet header information 1000.

The management terminal 19 transmits instruction information to the flow action table control unit 42 through the register 10. This information is to instruct to set information for instructing “ECE marking” into the flow action entry 1481 of the flow action table 148, set information for instructing “ECE marking in congestion” into the flow action entry 1482, set information for instructing “not-ECT marking” into the flow action entry 1483, and set information for instructing “ECE marking stoppage & not-ECT marking” into the flow action entry 1484. Then, the flow action table control unit 42 controls writing of the flow action entry 1481, the flow action entry 1482, the flow action entry 1483, and the flow action entry 1484, into the flow action table 148.

Upon input of the SYN-ACK packet with ECN non-support (ACK=1, SYN=1, ECE=0, CWR=0, and FIN=0) to the packet relay device of the embodiment 4, search activation control is performed by inputting the packet header information 1000 from the flow search table control unit 40 of the flow search unit 140 to the flow search table 147. As a result of the search, an address 1471-a of the flow search entry 1471 for SYN-ACK packet detection is output from the flow search table 147. This entry coincides with the packet header information 1000 of the corresponding packet. This address 1471-a is input to the flow action table control unit 142, and reading of the flow action table 143 is controlled using this address 1471-a as a read address. Then, information for instructing “ECE marking” is read from the flow action entry 1481. The information representing “ECE marking” is transmitted to the packet receiving buffer control circuit 1600 of the packet receiving circuit 160. The packet header information 1000 of the corresponding packet is controlled to be read from the packet receiving buffer 1601, and is rewritten into ECE=1 of the corresponding packet. In the packet relay device of this embodiment, the SYN-ACK packet with ECN non-support is rewritten into an ECN-setup SYN-ACK packet with ECN support (that is, SYN-ACK in which ACK=1, SYN=1, ECE=1, CWR=0, and FIN=0), and is transmitted. When the transmitting terminal receives this ECN-setup SYN-ACK packet, it transmits the ACK packet to the receiving terminal. Then, the TCP 3 way handshake process regarding the ECN support communication is completed.

When the ECE support communication starts, a DATA (ECT) packet (ECN=01, 10, or 11) is input to the packet relay device of this embodiment. When the DATA (ECT) (ACK=0, SYN=0, ECE=0, CWR=0, FIN=0) is input to the packet relay device of this embodiment, search activation control is performed by inputting the packet header information 1000 from the flow search table control unit 40 of the flow search unit 140 to the flow search table 147. As a result of the search, an address 1473-a of the flow search entry 1473 for DATA (ECT) packet detection is output from the flow search table 147. Note that this entry 1473 coincides with the packet header information 1000 of the corresponding packet. The address 1473-a is input to the flow action table control unit 142, and the flow action table 143 is controlled to be read using the address 1473-a as a read address. Information representing “not-ECT marking” is read from the flow action entry 1483. The information representing “not-ECT marking” is transmitted to the packet receiving buffer control unit 1600 of the packet receiving circuit 160, the packet header information 1000 of the corresponding packet is controlled to be read from the packet receiving buffer 1601, and it is rewritten to ECN=00. The DATA (ECT) packet with ECN support is rewritten into a DATA (not-ECT) packet with ECN non-support is transmitted in the packet relay device of this embodiment. As a result, a data packet with ECN support transmitted from the transmitting terminal is rewritten into a data packet with ECN non-support in the packet relay device of this embodiment, thus enabling to conceal the ECN communication for the receiving terminal as non-ECN communication.

Upon input of an ACK packet (ACK=1, SYN=0, ECE=0, CWR=0, and FIN=0) for a data packet with non-ECN support which has been rewritten by the packet relay device of this embodiment, into the packet relay device of this embodiment, search activation control is performed by inputting the packet header information from the flow search table control unit 40 of the flow search unit 140 to the flow search table 147. As a result of the search, an address 1472-a of the flow search entry 1472 for ACK packet detection is output from the flow search table 147. The entry 1472 coincides with the packet header information 1000 of the corresponding packet. This address 1472-a is input to the flow action table control unit 142, and the flow action table 143 is controlled to be read using this address 1472-a as a read address. Information for instructing “ECE marking in congestion” is read from the flow action entry 1482. The information representing “ECE marking in congestion” is transmitted to the congestion state table control unit 1606 for each buffer of the packet receiving circuit 160, the congestion state management table 1607 is controlled to be read by the congestion state management table control unit 1606 for each buffer, so as to read a congestion state flag of a buffer accumulating the data packet corresponding to the ACK packet. When this congestion state flag has a value representing that it is in a congestion state, the packet receiving buffer control unit 1600 controls to read the packet header information 1000 of the corresponding ACK packet of the packet receiving buffer 1601, and performs a process for “ECE marking in congestion” for rewriting an ECE flag of the corresponding ACK packet into “1”.

Upon detection of congestion using the ECE marked ACK packet, a DATA (CWR) packet (ACK=0, SYN=0, ECE=0, CWR=1, and FIN=0) representing that congestion avoidance control has been performed by the transmitting terminal 1 is input to the packet relay device of this embodiment. In this case, search activation control is performed by inputting the packet header information 1000 from the flow search table control unit 40 of the flow search unit 140 to the flow search table 147. As a result of the search, an address 1474-a of the flow search entry 1474 for DATA (CWR) packet detection is output from the flow search table 147. Note that this entry coincides with the packet header information 1000 of the corresponding packet. Then, this address 1474-a is input to the flow action table control unit 142, and the flow action table 143 is controlled to be read using the address 1474-a as a read address. Information for instructing “ECE marking stoppage & not-ECT marking” is read from the flow action entry 1484. The information representing “ECE marking stoppage” is transmitted to a congestion state management table control unit 1-15 for each buffer. Then, the congestion state management table control unit 1606 for each buffer rewrites the value of the congestion state flag of the congestion state management entry for the buffer accumulating the corresponding packet in the congestion state management table 1607 for each buffer, into a value representing that it is not in a congestion state. Now, the ECE marking process for the ACK packet input to the packet relay device of this embodiment stops. The information representing “not-ECT marking” is transmitted to the packet receiving buffer control unit 1600 of the packet receiving circuit 160, the packet header information 1000 of the corresponding packet is controlled to be read from the packet receiving buffer 1601, and it is rewritten into ECN=00 and CWR=0. Then, the DATA (CWR) packet with ECN support is rewritten into a DATA (not-ECT) packet with ECN non-support in the packet relay device of this embodiment, and is transmitted thereafter. Then, the DATA (CWR) packet with ECN support transmitted from the transmitting terminal is written into a DATA (not-ECT) packet with non-ECT support in the packet relay device of this embodiment, thus enabling to conceal the ECN communication for the receiving terminal as non-ECN communication.

A FIN packet (ACK=0, SYN=0, ECE=0, CWR=0, and FIN=1) representing communication completion is input to the packet relay device of this embodiment. Upon this input, search activation control is performed by inputting the packet header information 1000 from the flow search table control unit 40 of the flow search unit 140 to the flow search table 147. As a result of the search, an address 1475-a of a flow search entry 1475 for FIN packet detection is output from the flow search table 147. This entry 1475 coincides with the packet header information 1000 of the corresponding packet. The address 1475-a is input to the flow action table control unit 142, and the flow action table 143 is controlled to be read using the address 1475-a as a read address. After this, information for instructing “delete ECN proxy” is read from the flow action entry 1485. Then, information for instructing “delete ECN proxy” is read from the flow action entry 1482. In the flow search table 147, the flow search table control unit 40 deletes the flow search entry 1475 for FIN packet detection, and four entries located upstream of the present entry. The four entries include the flow search entry 1471 for SYN-ACK packet detection, the flow search entry 1472 for ACK packet detection, the flow search entry 1473 for DATA (ECT) packet detection, and the flow search entry 1474 for DATA (CWR) packet detection. The flow action table control unit 142 deletes the flow action entries 1481 to 1485. After completion of the ECN communication, the unit deletes an ECN proxy-related flow search entry and an ECN proxy-related flow action entry which belong to the corresponding flow. Descriptions will now be made of a flowchart including the process in the above-described packet relay device of this embodiment and a sequence diagram briefly including communication of this embodiment which is performed between the transmitting terminal, the receiving terminal, and the packet relay device.

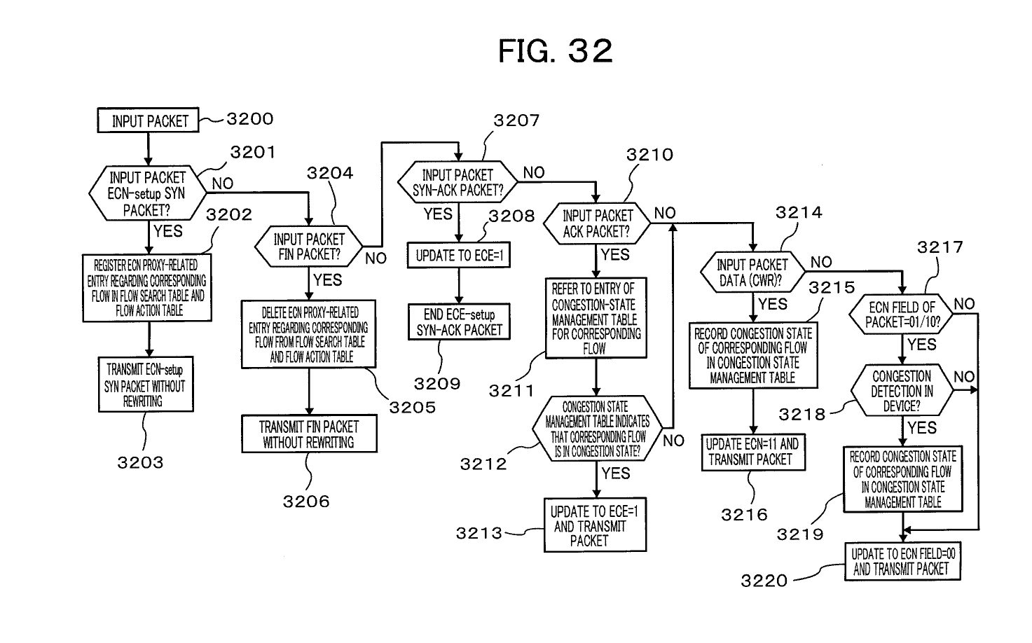

FIG. 32 shows a flowchart of a process in the packet relay device of this embodiment.

The flowchart of FIG. 32 is made on the assumption that the receiving terminal is a terminal with ECN non-support.

In this embodiment, for the process flow of FIG. 23 in the embodiment 1, an ECN-setup SYN packet is input to the packet relay device of this embodiment. Then, a process for registering ECN proxy-related entries is added. The ECN proxy-related entries include the flow search entry 1471 for SYN-ACK packet detection, the flow search entry 1472 for ACK packet detection, the flow search entry 1473 for DATA (ECT) packet detection, the flow search entry 1474 for DATA (CWR) packet detection, and the flow search entry 1475 for FIN packet detection. When the FIN packet is input to the packet relay device of this embodiment, a process for deleting the ECN proxy-related entries is added. The ECN proxy-related entries include the flow search entry 1471 for SYN-ACK packet detection, the flow search entry 1472 for ACK packet detection, the flow search entry 1473 for DATA (ECT) packet detection, the flow search entry 1474 for DATA (CWR) packet detection, and the flow search entry 1475 for FIN packet detection. When the SYN-ACK packet is input to the packet relay device of this embodiment, a process for rewriting the corresponding packet into an ECN-setup SYN-ACK packet (ECE=1) and transmitting it is added. When the DATA (CWR) packet is input to the packet relay device of this embodiment, a process for rewriting the corresponding packet into a packet with ECN non-support (ECN=00) and transmitting it is padded. When any other data packet is input to the packet relay device, a process for rewriting the corresponding packet into a packet with ECN non-support (ECN=00) and transmitting it is added.

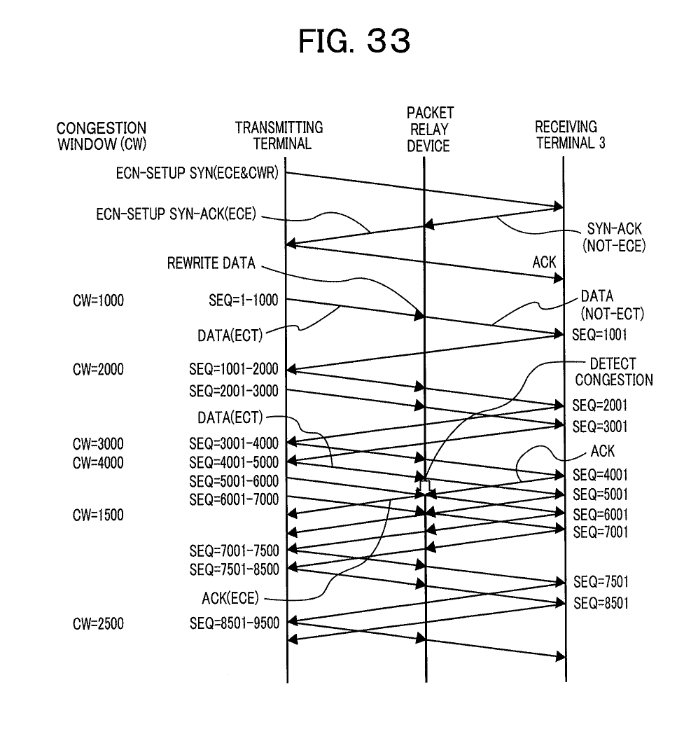

Finally, FIG. 33 shows a sequence diagram of communication using the packet relay device of this embodiment. The sequence diagram of this embodiment includes some additional processes into the sequence diagram of FIG. 24 in the embodiment 1. The additional processes include, “Initialize with 3 way-handshake”, an ECN proxy process for acting a substitute for performing the ECN procedures in the receiving terminal 3 in the packet relay device 2 and a process for rewriting DATA (ECT) or DATA (CWR) into DATA (not-ECT) for concealing ECN communication for the receiving terminal 3.

As described, the descriptions have so far been made to various embodiments of the present invention. The present invention is not limited to the above embodiments, and various modifications may be made. For example, the above-described embodiments have specifically been described for easy explanation. Therefore, the present invention is not limited to that including the entire constituent elements. The configuration of one embodiment may partially be replaced by the configuration of any other embodiment, and the configuration of one embodiment may be added to the configuration of another embodiment. The configuration of each embodiment may partially be added, deleted, and replaced with, from, and by the configuration of another embodiment.

Each of the above-described configuration, function, processing unit, and processing means may partially or entirely be realized using the hardware (for example, with a design using an integrated circuit). Each of the above-described configuration and function is realized by executing the program realizing each of the functions. Information of a program, a table, and a file may be put in some recording unit, such as a memory, a hard disk, SSD (Solid State Drive) or a recording medium, such as an IC card, an SD card, a DVD, or may be downloaded or installed through a network, as needed.

As specifically be described above, in this specification, various inventions are disclosed other than the inventions disclosed in the claims, and a part of the inventions will now be listed as application examples.

### Application Example 1

A packet relay device comprising a plurality of input lines and output lines, and

wherein the device detects a flow of a set of packets identified by at least one information item of an input physical line number of a packet received from an input line, an input logical line number, or packet header information, and

the device rewrites a field representing a congestion state of a network in a packet header of a response packet corresponding to the flow and received by the packet relay device thereafter, into a value representing that it is in a congestion state, when the packet relay device determines that the flow is in a congestion state.

### Application Example 2

The packet relay device of Application example 1, further comprising a congestion state management table which includes a congestion state flag for each flow and records a congestion state of each flow,

wherein the device rewrites the congestion state flag of the corresponding flow into a value representing that it is in a congestion state, when the packet relay device determines that it is in a congestion state,

the device rewrites the congestion state flag of the corresponding flow into a value representing that it is in a non-congestion state, when the packet relay device determines that the congestion state is solved in the flow,

the device rewrites a value of the field representing the congestion state of the network into a value representing that it is in a congestion state, in the packet header of the response packet, in accordance with the congestion state flag of a flow to which the response packet belongs, when the congestion flag represents a congestion, by referring to the congestion state management table when the packet relay device receives a response packet, and

the device rewrites the value of the field representing the congestion state of the network in the packet header of the response packet, into a value representing that it is in a non-congestion state when the congestion state flag represents a non-congestion state.

### Application Example 3

The packet relay device of Application example 2,

wherein the packet relay device determines that the congestion state solved in the flow, when information representing that a transmitting terminal has controlled congestion avoidance includes a value representing that congestion avoidance has been performed, of packet header information of the received packet.

### Application Example 4

The packet relay device of Application example 3, wherein the device determines that the congestion state solved in the flow, when a CWR flag of a received TCP packet is “1”.

### Application Example 5

The packet relay device of any one of Application examples 2 to 4,

wherein the flow is a TCP flow, a DCCP flow, or an SCTP flow having the same combination of an source IP address, a destination IP address, a source port number, and a destination port number, an IP flow having the same combination of a source IP address and a destination IP address, a VLAN flow belonging to the same VLAN, or a flow defined in combination with arbitrary packet header information items specified by an operation manager of the packet relay device.

### Application Example 6

The packet relay device of any one of Application examples 2 to 5,

wherein the congestion state flag for each flow is included only for a particular flow specified by the operation manager of the packet relay device.

### Application Example 7

The packet relay device of any one of Application example 1 to 6,

wherein the field representing the congestion state of the network is an ECE flag of the TCP packet, in the packet header of the response packet.

### Application Example 8

The packet relay device of any one of Application example 1 to 7,

wherein it is determined that the flow is in a congestion state, when a queue length of a shaper, a bucket water amount of a policer, or the number of packets accumulated in a buffer exceeds a predetermined threshold value.

### Application Example 9

The packet relay device of any one of Application examples 1 to 7,

wherein it is determined that the flow is in a congestion state, based on a value of the field representing the congestion state of the network, in the packet header of the received packet.

### Application Example 10

The packet relay device of Application example 9,

wherein the field representing the congestion state of the network in the packet header of the received packet is an ECN field of an IP packet.

### Application Example 11

The packet relay device of Application examples 1 to 10,

wherein the device rewrites a value of a field representing support availability of a congestion notification function from a value representing non-support of the congestion notification function into a value representing support of the congestion notification function, in a packet header of a control packet for informing about support availability information of the congestion notification function between a transmitting and receiving terminals, the packet being transmitted from a receiving terminal which does not support the congestion notification function.

### Application Example 12

The packet relay device of Application example 11,

wherein the device rewrites a SYN-ACK packet without an ECE flag set thereto in a 3 way handshake process using an ECN initialization procedure and transmitted from the receiving terminal which does not support the congestion state function using ECN, into a SYN-ACK packet with an ECE flag set thereto.

### EXPLANATION OF NUMERALS

1 . . . Transmitting Terminal
2 . . . Packet Relay Device
3 . . . Receiving Terminal
14 . . . Data
15 . . . Data (CE)
16 . . . ACK
17 . . . ACK (ECE)
18 . . . Data (CWR)
19 . . . Management Terminal
21, 160 . . . Packet Receiving Circuit
22 . . . Packet Search Unit
23 . . . Route Search Unit
24, 140 . . . Flow Search Unit
25 . . . Bandwidth Monitoring Unit
26 . . . Packet Relay Processing Means
27 . . . Packet Search Unit
28 . . . Packet Transmitting Circuit
29 . . . Register
30 . . . Output Line
40 . . . Flow Search Table Control Unit
41, 145, 147 . . . Flow Search Table
50 . . . Bandwidth Monitoring Table Control Unit
51 . . . Bandwidth Monitoring Table
52 . . . Current Water Amount Determining Unit
53 . . . Monitoring Result Determining Unit
54 . . . Congestion State Management Unit
101 . . . Internal Header Unit
102 . . . L2 Header Unit
103 . . . L3 Header Unit
104 . . . L4 Header Unit
142 . . . Flow Action Table Control Unit
143, 144, 1446, 148 . . . Flow Action Table
210, 1600 . . . Packet Receiving Buffer Control Unit
211, 1601 . . . Packet Receiving Buffer
212, 1602 . . . Buffer Accumulation Packet Number Management Unit
1000 . . . Packet Header Information

1. A packet relay device which relays a packet, comprising:
a plurality of input lines and output lines, and a packet search unit which searches for a packet received from the input line,
wherein the packet search unit detects a flow including a set of packets identified by information of the packet received from the input line, and
when determined that the detected flow is in a congestion state, the packet search unit rewrites a field representing a congestion state into a value representing that it is in a congestion state, in a header of a response packet for the flow received thereafter.

2. The packet relay device according to claim 1,
wherein the packet search unit:
includes a congestion state management table which includes a congestion state flag for each flow and for recording the congestion state of each flow;
rewrites the congestion state flag of a flow into a value representing that it is in a congestion state, when determined that the corresponding flow is in a congestion state;
rewrites a congestion state flag of a flow into a value representing that it is in a non-congestion state, when determined that the congestion state is solved in the flow; and
upon reception of a response packet, rewrites a value of a field representing a congestion state of a network in a packet header of the response packet, when a congestion state flag represents a congestion, in accordance with the congestion state flag of a flow to which the response packet belongs, with reference to the congestion state management table.

3. The packet relay device according to claim 2, wherein the packet search unit determines that the congestion state is solved in the flow, when, of packet header information received from a transmitting terminal, information representing that the transmitting terminal has performed congestion avoidance control has a value representing that the congestion avoidance has been performed.

4. The packet relay device according to claim 2, wherein the flow is a TCP flow, a DCCP flow, or an SCTP flow having the same combination of a source IP address, a destination IP address, a source port number, and a destination port number, an IP flow having the same combination of a source IP address and a destination IP address, or a VLAN flow belonging to the same VLAN.

5. The packet relay device according to claim 2, wherein the congestion state management table includes a congestion state flag for each flow, only for a particular flow specified by an operation manager.

6. The packet relay device according to claim 1, wherein the packet search unit determines that the flow is in a congestion state, based on a value of a field representing a congestion state of a network, in a packet header of the received packet.

7. The packet relay device according to claim 1, wherein the packet search unit rewrites a value of a field representing support availability of a congestion notification function from a value representing non-support of the congestion notification function into a value representing support of the congestion notification function, in a packet header of a control packet for informing about support availability of the congestion notification function between a transmitting and receiving terminals, the packet being transmitted from a receiving terminal which does not support the congestion notification function.

8. The packet relay device according to claim 7,
wherein the receiving terminal is a receiving terminal which does not support the congestion notification function using ECN; and
the packet search unit rewrites a SYN-ACK packet without an ECE flag set thereto in a 3 way handshake process using an ECN initialization procedure, as the control packet, into a SYN-ACK packet with an ECE flag set thereto.

9. A packet relay method for a packet relay device including a plurality of input lines and output lines, the method comprising:
detecting a flow including a set of packets identified by information of a packet received from the input line; and
when determined that the detected flow is in a congestion state, rewriting a field representing a congestion state into a value representing that it is in a congestion state, in header information of a response packet for the corresponding flow, the packet being received thereafter.

10. The packet relay method according to claim 9,
wherein the packet relay device includes a congestion state management table including a congestion state flag and recording a congestion state of each flow,
when determined that a flow is in a congestion state, the packet relay device rewrites the congestion state flag of the corresponding flow into a value representing that it is in a congestion state, and when determined that the congestion state is solved in a flow, the packet relay device rewrites the congestion state of the corresponding flow into a value representing that it is in a non-congestion state, and
upon reception of a response packet, the packet relay device rewrites a value of a field representing a congestion state of a network in a packet header of the response packet, in accordance with a congestion state flag of a flow to which the response packet belongs to, with reference to the congestion state management table.

11. The packet relay method according to claim 9, wherein, of header information of a packet received from a transmitting terminal, information representing that the transmitting terminal has performed congestion avoidance control has a value representing that congestion avoidance has been performed, it is determined that the congestion state is solved in the flow.

12. The packet relay method according to claim 9, wherein the flow is a TCP flow, a DCCP flow, or an SCTP flow having the same combination of a source IP address, a destination IP address, a source port number, a destination port number, an IP flow having the same combination of a source IP address and a destination IP address, or a VLAN flow belonging to the same VLAN.

13. The packet relay method according to claim 9, wherein it is determined that the flow is in a congestion state, based on a value of a field representing a congestion state of a network in a packet header of the received packet.

14. The packet relay method according to claim 9, wherein, in a packet header of a control packet for informing about support availability of a congestion notification function and transmitted from a receiving terminal which does not support the congestion notification function, a value of a field representing support availability of the congestion notification function is rewritten from a value representing non-support of the congestion notification function into a value representing support of the congestion notification function.

15. The packet relay method according to claim 14,
wherein the receiving terminal is a receiving terminal which does not support a congestion notification function using ECN, and
the packet relay device rewrites a SYN-ACK packet without an ECE flag set thereto in 3 way handshake process using an ECN initialization procedure, as the control packet, into a SYN-ACK packet with an ECE flag set thereto.
